(19) United States
(12) Patent Application Publication
(10) Pub. No.: US 2024/0415060 A1
(43) Pub. Date: Dec. 19, 2024

(54) ARTICULATED MOWER APPARATUSES

(71) Applicant: MTD PRODUCTS INC, Valley City, OH (US)

(72) Inventors: Jay Maggard, Polk, OH (US); Jeffrey Kucera, Medina, OH (US)

(21) Appl. No.: 18/747,697

(22) Filed: Jun. 19, 2024

Related U.S. Application Data
(60) Provisional application No. 63/521,764, filed on Jun. 19, 2023.

(51) Int. Cl. A01D 67/00; A01D 34/66; A01D 34/86

(52) U.S. Cl. CPC A01D 67/00; A01D 34/66; A01D 34/86

(57) ABSTRACT

Provided is an articulated mower apparatus, comprising a first deck and a second deck. The first deck has a right, left, front, back, top and bottom, a first blade and a first caster. The first blade is rotatable with the first deck and operable to contribute to mowing. The first caster is adapted to support the first deck above a surface. The second deck is engaged with the first deck at a side by a linkage defining an articulation axis. The linkage is adapted to permit the second deck to rotate about the first articulation axis with respect to the first deck. The second deck has: a rotatable blade and is adapted to contribute to mowing; a second caster adapted to support the second deck above the surface; and a drive roller. Also provided are related mower systems.

### CROSS-REFERENCE TO RELATED APPLICATION

This application claims the benefit of U.S. Provisional Application No. 63/521,764, filed Jun. 19, 2023.

### FIELD OF DISCLOSURE

The disclosed subject matter generally pertains to apparatuses for power equipment for outdoor maintenance applications. More specifically, the disclosed subject matter pertains to apparatuses for performing mowing operations related to a mower having articulated mowing decks and for support of such mower components.

### BACKGROUND AND SUMMARY

Manufacturers of power equipment for outdoor maintenance applications (e.g., mowers) offer many types of machines for general maintenance and mowing applications. Generally, these machines can have a variety of forms depending on application, from general urban or suburban lawn maintenance, rural farm and field maintenance, to specialty applications. Even specialty applications can vary significantly.

Conventional fixed decks for mowers have a frame which fixes one or more mowing heads in both position and orientation with respect to the frame and to one another. For applications involving mowing over an uneven surface, alternatively referred to hereafter as a contoured ground, as a conventional deck moves over the uneven surface, a suspension for one or more wheels allows the deck to comply with the surface up to a limit defined in part by the size of the deck. As decks become larger, it is more difficult for the suspension to provide effective compliance with smaller features of the uneven ground such that small bumps or grooves fall between the suspension elements and are not complied with. Failure to comply with ground features may lead to scalping or otherwise incorrect mow height or other improper or undesirable mowing results.

One way to provide a mowing deck that provides greater freedom to move and comply with contoured ground than that of conventional fixed decks is to provide an articulated deck. An articulated deck may comprise a plurality of decks with each deck suspended from a conventional frame and one or more decks being rotatable about at least one axis with respect to the frame. The frame in turn may be adapted to roll over contoured ground during a mowing operation mowed on one or more wheels conventionally engaged therewith. This form of an articulated deck still has the problem that the wheels themselves on which the frame rolls on do not comply with the contoured ground. This can lead to poor results in the form of damaged or deformed ground left by a wheel impression thereon or interaction therewith, such as a groove or divot or track. It remains desirable to develop articulated mowing apparatuses in which the support wheels or rollers are adapted to comply with contoured ground. Further, it remains desirable to develop systems and apparatus adapted to operate in conjunction with articulated mowing apparatuses in which the support wheels or rollers are adapted to comply with contoured ground in order to provide a stable operational platform, suspension, and other related functionality.

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Various embodiments of the present disclosure relate to an articulated mower apparatus. In a first non-limiting embodiment, an articulated mower apparatus comprises a first deck and a second deck operationally engaged with the first deck at a side thereof by a first linkage adapted to permit the second deck to change in orientation with respect to the first deck within a first limited range of orientations. In this latter first embodiment, the first deck has a first deck right side and a first deck left side offset from the first deck right side in a width direction by a first deck width; a first deck front and a first deck back offset from the first deck front in a depth direction by a first deck depth; a first deck top and a first deck bottom offset from the first deck top in a height direction by a first deck height; a first blade rotatably engaged with the first deck and adapted to perform a mowing operation; and a first caster engaged therewith and adapted to support the first deck above a surface being mowed. In this latter first embodiment, the second deck has a second blade rotatably engaged with the second deck and adapted to perform a mowing operation, and a second caster engaged therewith and adapted to support the second deck above the surface being mowed.

Some embodiments of the present disclosure relate to a movably combined mower subframe. In a first non-limiting embodiment, a movably combined mower subframe, comprises a plurality of decks and an articulated drive system engaged to the plurality of decks. The plurality of decks has a first deck extending in a width direction, a height direction, and a depth direction; a second deck; and a third deck. The second deck is connected to the first deck by a first linkage defining a first axis of articulation about which the second deck may rotate, and the third deck is connected to the first deck by a second linkage defining a second axis of articulation about which the third deck may rotate. The articulated drive system has a second deck drive roller and a third drive roller. The second drive roller is operationally engaged with the second deck to rotate about a second deck drive axis fixedly oriented with respect to the second deck; and is adapted to rotate along with the second deck about the first axis of articulation; and adapted to apply work between a surface and the second deck to promote motion of the second deck with respect to the surface. The second deck drive axis and the first axis of articulation may be either i) perpendicular or ii) mutually orthogonal to a common perpendicular vector. The third deck drive roller is operationally engaged with the third deck to rotate about a third deck drive axis fixedly oriented with respect to the third deck; adapted to rotate with the third deck about the second axis of articulation; and is adapted to apply work between a surface and the third deck to promote motion of the third deck with respect to the surface. The third deck drive axis and the second axis of articulation may be either i) perpendicular or ii) mutually orthogonal to a common perpendicular vector. In this latter first non-limiting embodiment of a movably combined mower subframe the first linkage provides sufficient structural integrity to transmit sufficient work between the second deck to the first deck to move the first deck and the second deck over the surface during a mowing operation; and the second linkage provides sufficient structural integrity to transmit sufficient work between the third deck to the first deck to move the first deck and the third deck over the surface during a mowing operation.

Some embodiments of the present disclosure relate to a mower operation platform. In a first non-limiting embodiment, a mower operation platform comprises a first deck and an operator frame, wherein the operator frame is supported by the first deck through one or more support elements. In these latter non-limiting embodiments of a mower operation platform, the first deck is supported by one or more wheels, and has an operationally engaged mower blade. In these latter non-limiting embodiments of a mower operation platform, the operator frame has an operator frame first side and an operator frame second side opposite from the first operator frame first side and offset in a width direction by an operator frame width; an operator frame front and an operator frame back opposite from the operator frame front and offset in a depth direction by an operator frame depth; and an operator frame top and an operator frame bottom opposite the operator frame top and offset in a height direction by an operator frame height.

Some embodiments of the present disclosure relate to an active height adjustment mower suspension. In a first non-limiting embodiment, an active height adjustment mower suspension comprises a mower deck having an operationally engaged mower blade; and a slider-crank mechanism engaged with the mower deck. The slider-crank has a crank defining a height adjustment axis about which the crank is rotatably mounted to the mower deck, and a drive axis offset from the height adjustment axis by a fixed adjustment distance. The slider-crank also has a slider defined by a linear actuator, the linear actuator having a first actuator end operatively engaged to the mower deck, and a second actuator end operatively engaged to the crank to transmit work to rotate the crank about the height adjustment axis. In this latter first non-limiting embodiment of an active height adjustment mower suspension rotation of the crank about the height adjustment axis changes the position of the drive axis with respect to the mower deck.

Some embodiments of the present disclosure relate to a passive height adjustment mower suspension. In a first non-limiting embodiment, a passive height adjustment mower suspension comprises a mower deck having an operationally engaged mower blade; and a slider-crank mechanism engaged with the mower deck. The slider-crank has a crank defining a height adjustment axis about which the crank is rotatably mounted to the mower deck, and a roller axis offset from the height adjustment axis by a fixed adjustment distance. The slider-crank also has a slider defined by a slider spring, the slider spring having a first slider spring end operatively engaged to the mower deck, and a second slider spring end operatively engaged to the crank to passively output energy stored in the slider spring to rotate the crank about the height adjustment axis. In this latter first non-limiting embodiment of a passive height adjustment mower suspension, rotation of the crank about the height adjustment axis changes the position of the roller axis with respect to the mower deck.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 shows a perspective view of a first embodiment of an articulated mower apparatus.

FIG. 1A shows a close-up view of a first linkage of the first embodiment of an articulated mower apparatus.

FIG. 1B shows a close-up view of a second linkage of the first embodiment of an articulated mower apparatus.

FIG. 1C shows a simplified diagram of a third deck of the first embodiment of an articulated mower apparatus.

FIG. 1D shows a simplified diagram of a first deck of the first embodiment of an articulated mower apparatus.

FIG. 1E shows a simplified diagram of a second deck of the first embodiment of an articulated mower apparatus.

FIG. 2 shows a front view of the first embodiment of an articulated mower apparatus.

FIG. 3 shows a rear view of the first embodiment of an articulated mower apparatus.

FIG. 4 shows a left side view of the first embodiment of an articulated mower apparatus.

FIG. 5 shows a right side view of the first embodiment of an articulated mower apparatus.

FIG. 5A shows a close-up of the right side view of the first embodiment of an articulated mower apparatus.

FIG. 5B shows a close-up of the right side view of the first embodiment of an articulated mower apparatus.

FIG. 6 shows a top view of the first embodiment of an articulated mower apparatus.

FIG. 7 shows a bottom view of the first embodiment of an articulated mower apparatus.

FIG. 8 shows a perspective view of frame elements of the first embodiment of an articulated mower apparatus with other elements removed for visibility.

FIG. 8A shows a close-up perspective view of frame elements of the first embodiment of an articulated mower apparatus with other elements removed for visibility.

FIG. 9 shows a perspective view of a second embodiment of an articulated mower apparatus with some elements removed for visibility.

FIG. 10 shows a perspective view of the second embodiment of an articulated mower apparatus with some elements removed for visibility.

FIG. 11 shows a close-up perspective view of the second embodiment of an articulated mower apparatus with some elements removed for visibility.

FIG. 12 shows a close-up perspective view of the second embodiment of an articulated mower apparatus with some elements removed for visibility.

FIG. 13 shows a schematic diagram of a first embodiment of a first operation platform linkage.

FIG. 14 shows a schematic diagram of a first embodiment of a second operation platform linkage.

FIG. 15A shows a schematic diagram of a first operator frame support link.

FIG. 15B shows a schematic diagram of a second operator frame support link.

FIG. 16 shows a schematic diagram of a passive suspension slider-crank mechanism.

FIG. 17 shows a schematic diagram of a first deck caster parallelogram linkage.

FIG. 18 shows a schematic diagram of a second deck caster parallelogram linkage.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to an articulated mower apparatus are described herein, it should be understood that the disclosed apparatuses and methods are not so limited and modifications may be made without departing from the scope of the present disclosure. The scope of the systems, methods, and apparatuses are defined by the appended claims, and all devices, processes, and methods that come within the meaning of the claims, either literally or by equivalence, are intended to be embraced therein.

### DETAILED DESCRIPTION

Various embodiments can comprise an articulated mower apparatus according to various aspects discussed herein. As used herein, an articulated mower apparatus can be referred to as a “mower”, but it is understood that this term is not limiting and that other powered equipment for moving over and operating upon a contoured surface are also contemplated. An articulated mower apparatus can be a walk-behind mower or a ride-on mower of any of a variety of configurations, such as a seated mower, a standing mower, or a convertible seated/standing mower.

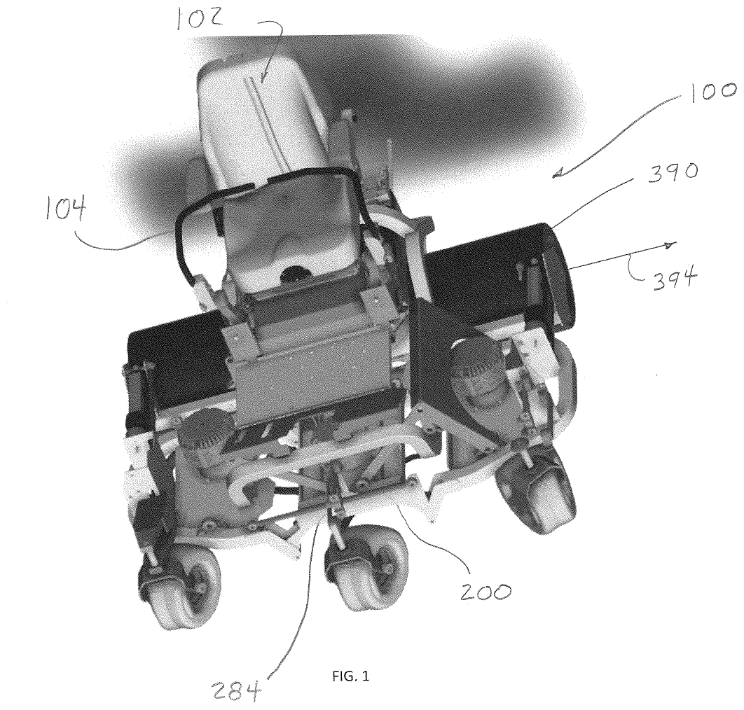

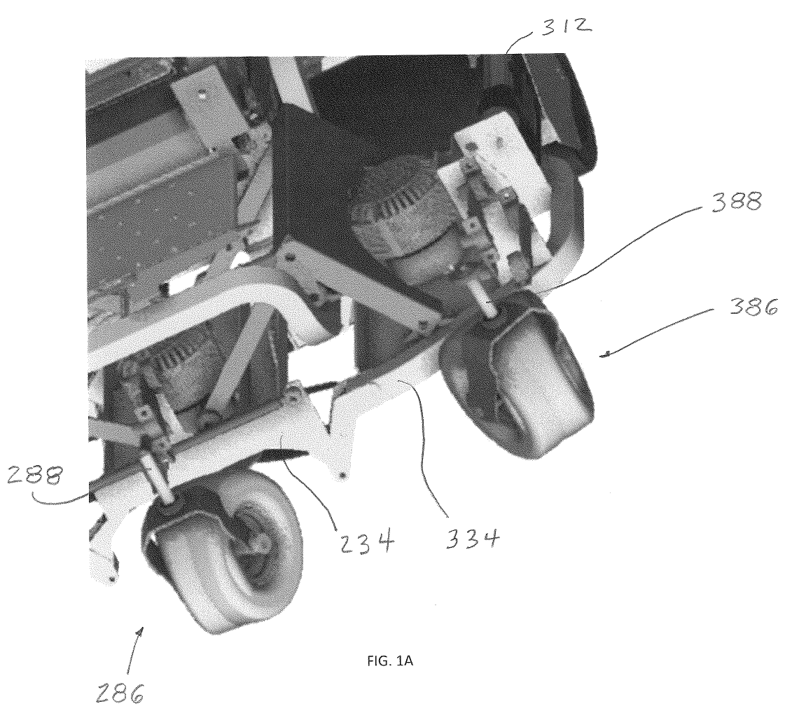

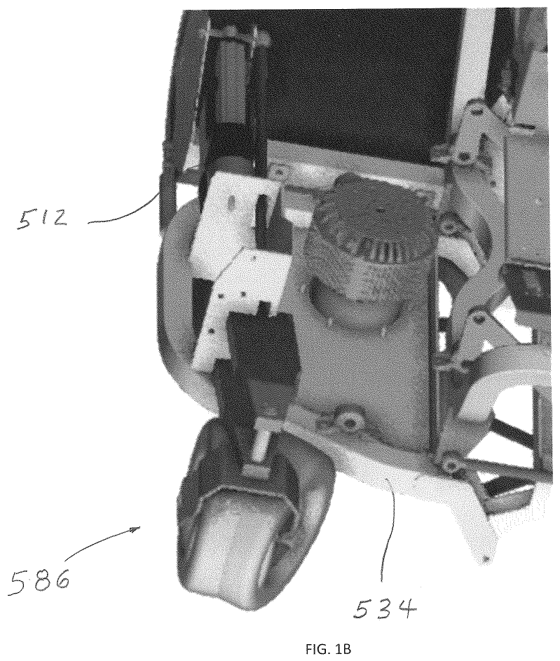

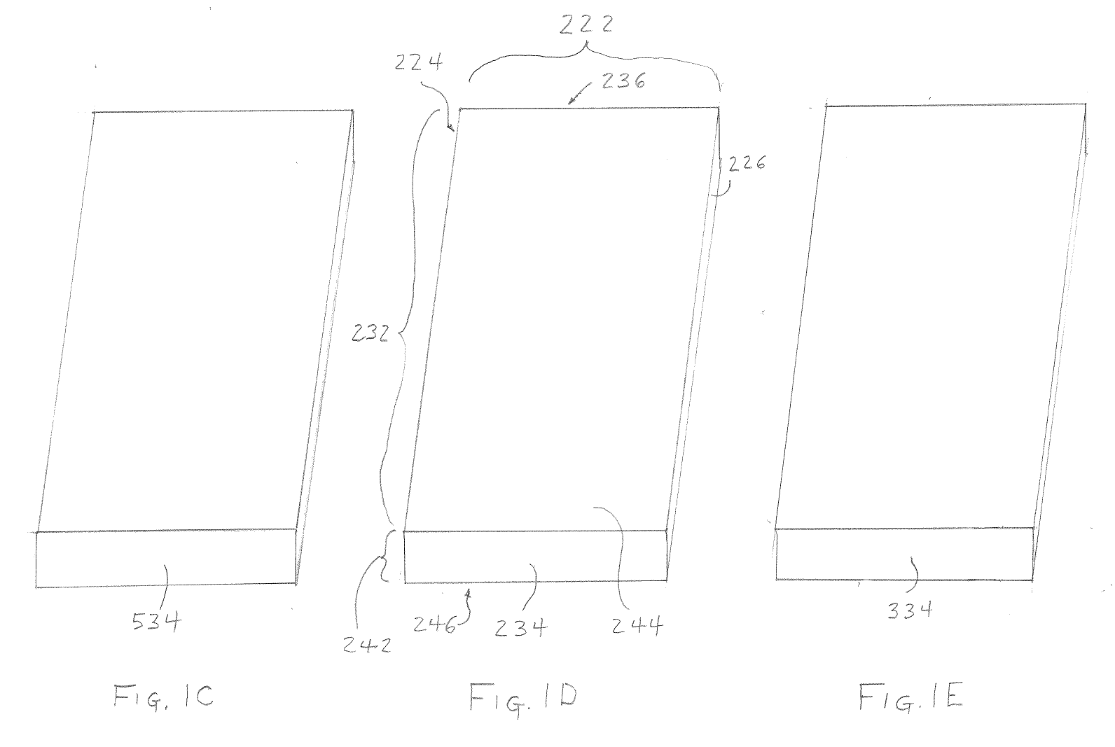

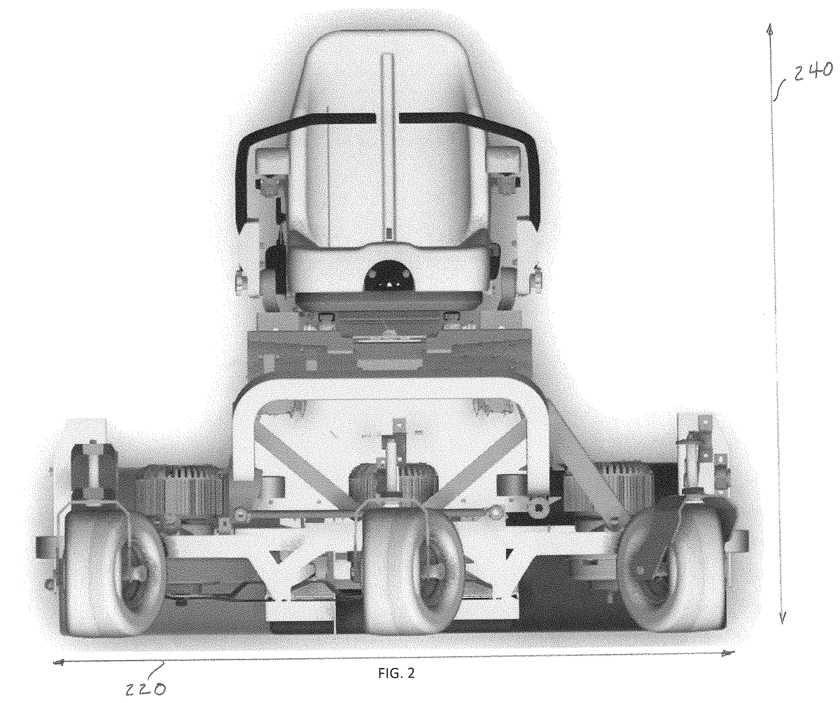

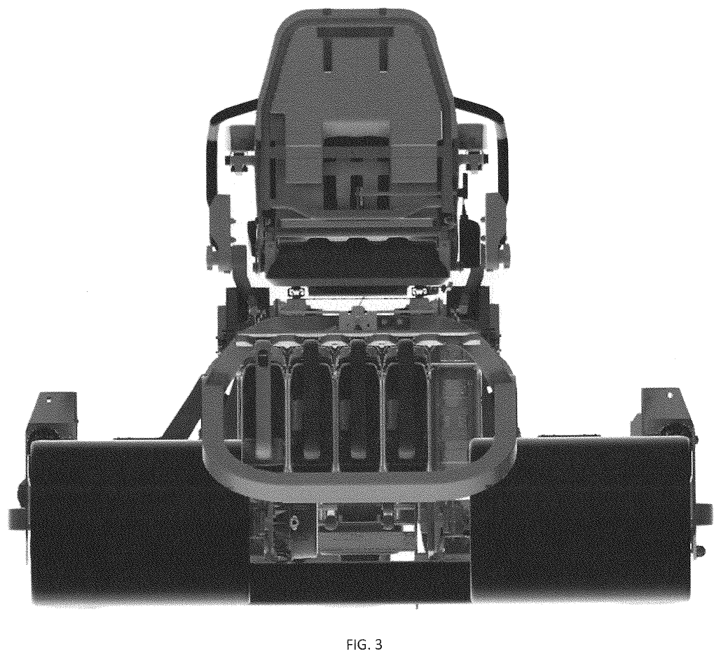

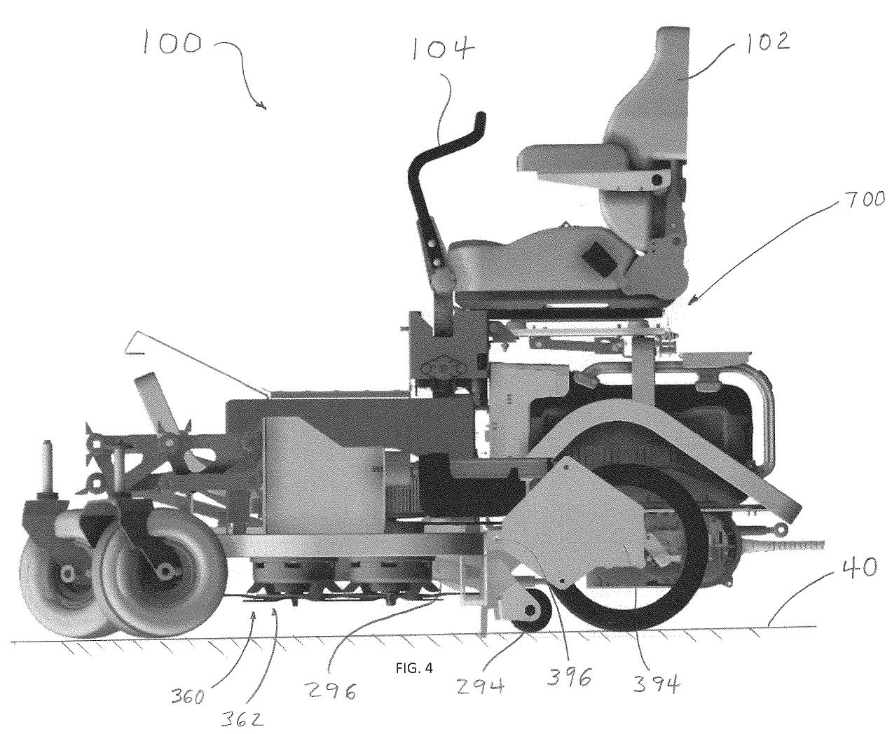

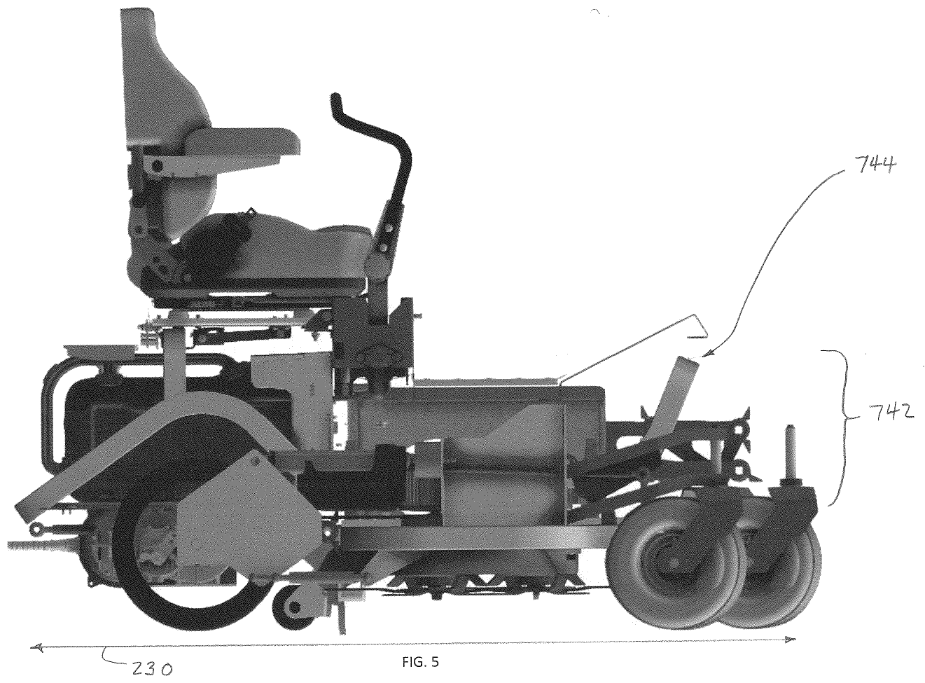

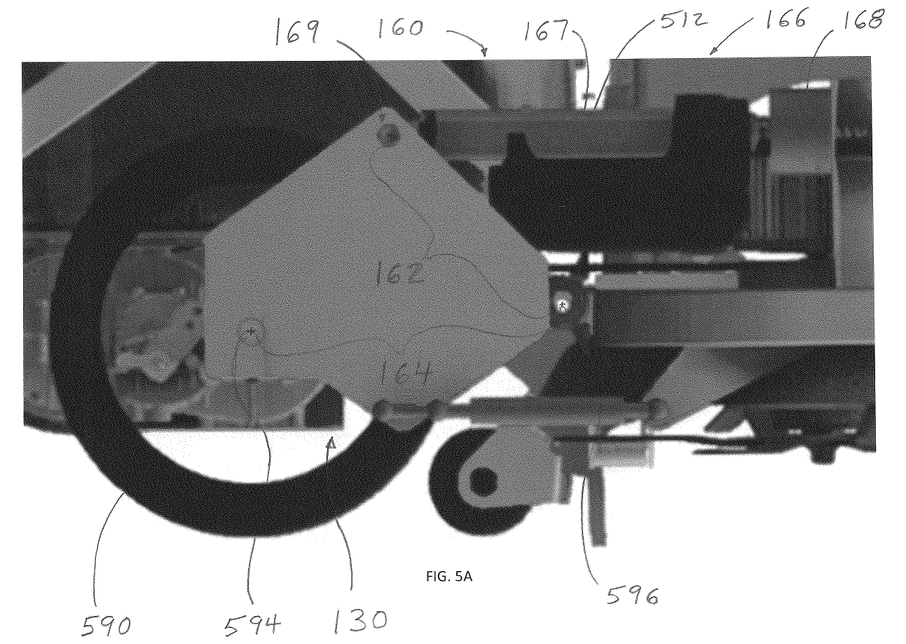

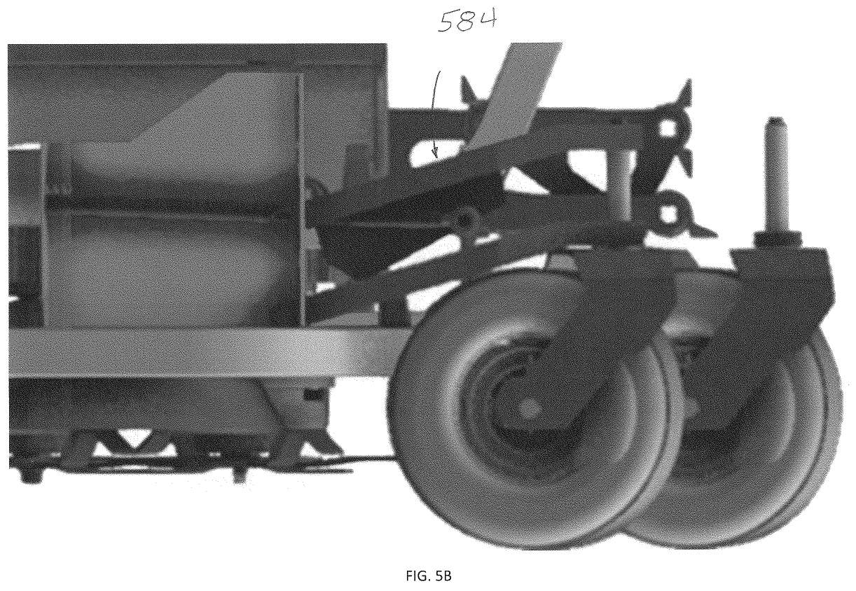

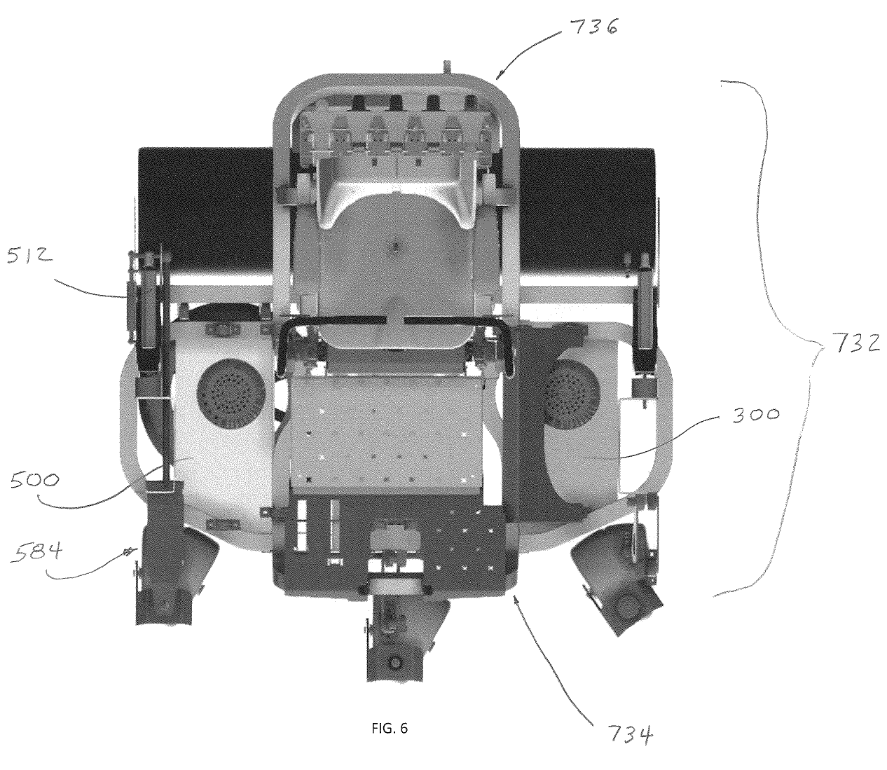

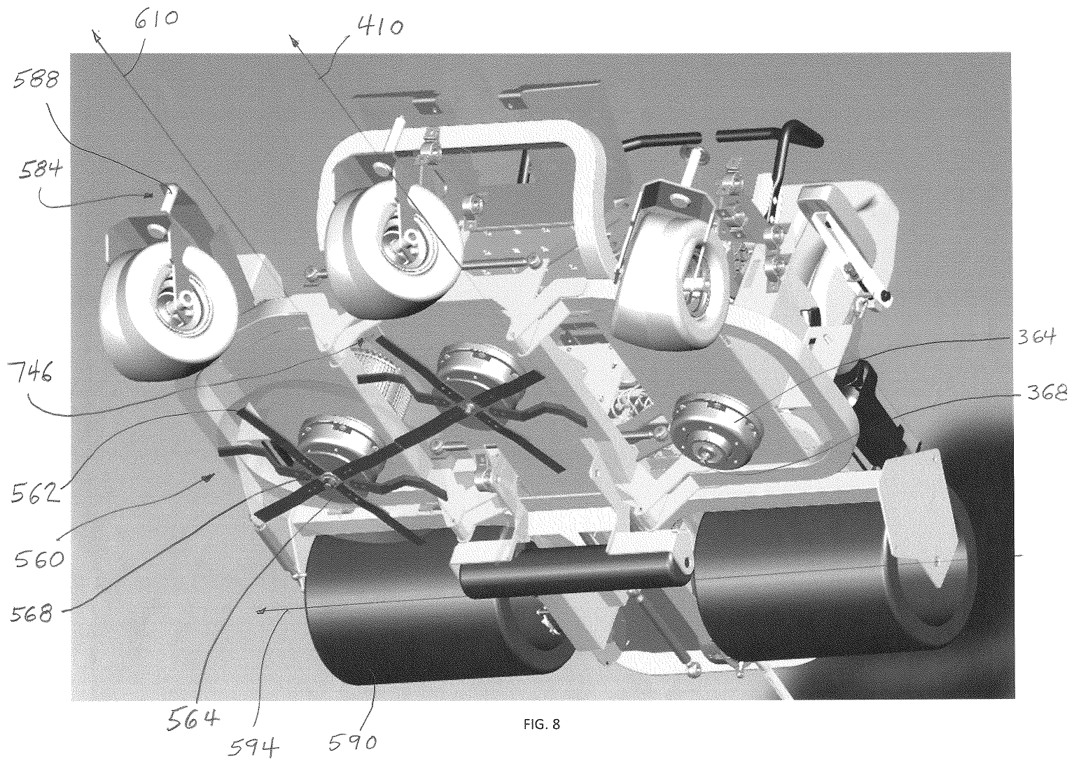

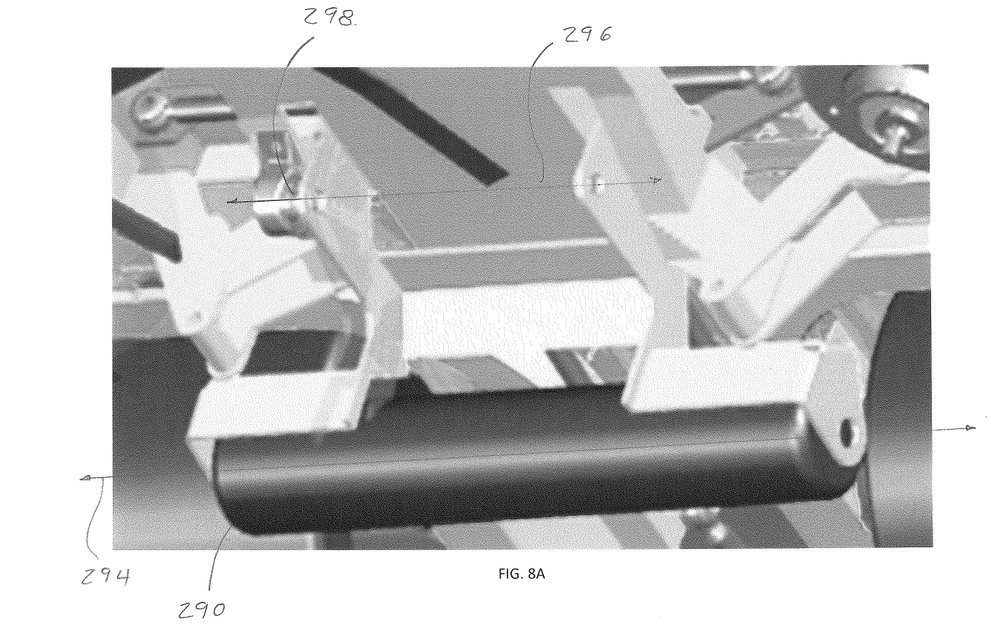

FIGS. 1-8A show a first non-limiting aspect of an articulated mower apparatus 100 employable as or in connection with various embodiments of the present disclosure. With reference now to FIG. 1, articulated mower apparatus 100 is shown as a seated operator apparatus providing a seat upon which the operator can control the articulated mower apparatus 100. It should be understood, however, that this latter aspect is not limiting; in other acceptable aspects of the disclosed subject matter articulated mower apparatus 100 can be adapted for a standing operator or may be a convertible standing/sitting articulated mower apparatus or may be adapted for a walking operator, or for robotic or automated operation. As illustrated in FIG. 1, articulated mower apparatus 100 allows an operator to ride in a seated position on an operator seat 102 with mower controls 104 for controlling powered operations of articulated mower apparatus 100 (e.g., drive functions, steering functions, and so forth, whether mechanical, electro-mechanical, hydraulic, pneumatic, or other suitable means of power operation).

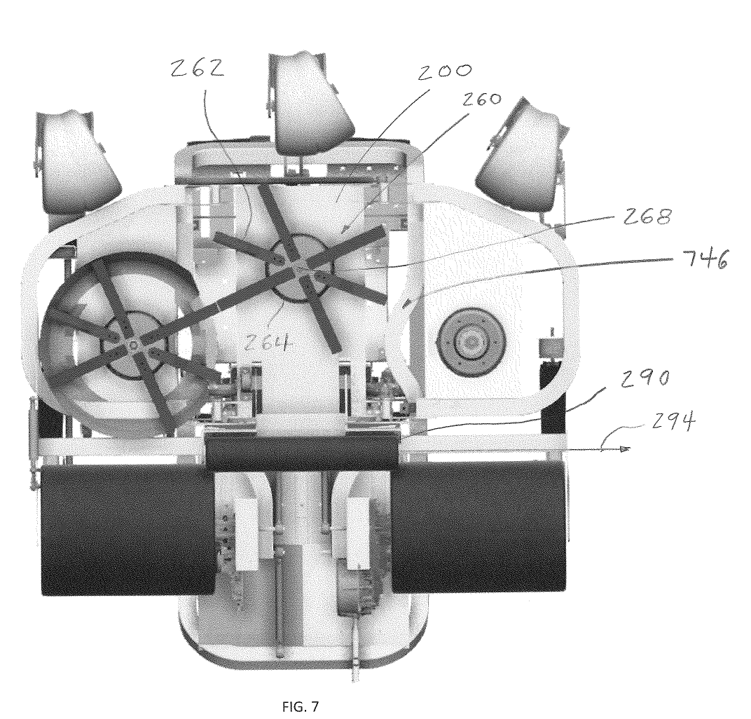

With continued reference to FIG. 1, and with further reference to FIGS. 1A, ID, and 7, articulated mower apparatus 100 comprises a first deck 200. First deck 200 is a mower deck and may approximate a substantially flat rectangular box. In the aspect shown in FIGS. 1, 1A, 1B, and 7, first deck 200 comprises a first deck right side 224 and a first deck left side 226 offset from the first deck right side 224 in a width direction 220 by a first deck width 222; a first deck front 234 and a first deck back 236 offset from the first deck front 234 in a depth direction 230 by a first deck depth 232; and a first deck top 244 and a first deck bottom 246 offset from the first deck top 244 in a height direction 240 by a first deck height 242.

As shown in FIGS. 4, 7 and 8, the first deck 200 comprises a first blade 262 rotatably engaged with the first deck 200 and adapted to perform or contribute to a mowing operation on a surface 40. It should be understood that the latter surface 40 could be a surface to be mowed and may be contoured or irregular in the height direction 240. The first blade 262 is part of a first blade set 260 comprising, in addition to the first blade 262, another zero, one, two or more additional blades. The first blade 262 may be operationally engaged with a first deck mow head 264 which is adapted to rotate the first blade 262, and the first blade set 260, at speeds appropriate to a mowing operation around a first blade operational axis 268. When so rotated at speeds appropriate to a mowing operation around a first blade operational axis 268, the first blade 262 may be operated to perform a mowing operation or to contribute to a mowing operation along with one or more other blades, for example but not limitation, a second blade or third blade as described herebelow, similarly in an operational state. This latter mowing operation may be to mow the surface 40. As is typical of a mow head, each mow head herein, e.g., the first deck mow head 264, the second mow head 364, the third mow head 564, defined the associated blade operational axis, about which the operationally engaged blade set is rotated during a mowing operation. In the embodiments shown, each mow head has its own local electrical motor to provide the work to operate the blade, but this is not limiting, and the work to operate the blade could, additionally or alternatively, come from a local combustion engine, or a belt or shaft or cable adapted to transmit work to the mow head from a distal combustion engine or electrical motor, or some combination of these. It is contemplated that the work so transmitted may optionally pass through one or more of a clutch, a transmission, a torque converter, a torque limiter, a flywheel, or a combination thereof. The first deck mow head 264 is substantially fixed with respect to the first deck 200. Herein, substantially fixed means that the mow head may move at most by an operationally trivial amount from its nominal position and orientation. Here it is to be understood that operationally trivial means that the motion does not adversely affect the quality of the mowing operation in a way that is deemed important using good engineering judgment. In some aspects, that operationally trivial amount is no more than 4 mm or 4 degrees from the nominal position and orientation. In some aspects, that operationally trivial amount is no more than 2 mm or 2 degrees from the nominal position and orientation. In some aspects, that operationally trivial amount is no more than 1 mm or 1 degree from the nominal position and orientation. In some non-limiting aspects, a mow head comprises a substantially rigid housing, such an aluminum alloy or steel alloy housing, which is bolted to a rigid steel alloy or aluminum alloy deck. In some non-limiting aspects, a mow head is engaged to a deck through a set of one or more springs or dampers or both that is adapted to protect components from shock, vibration or harmful torque or force transmission and which permit some operationally trivial motion. Accordingly, the first blade operational axis 268 defined by the first deck mow head 264 is similarly substantially fixed with respect to the first deck 200.

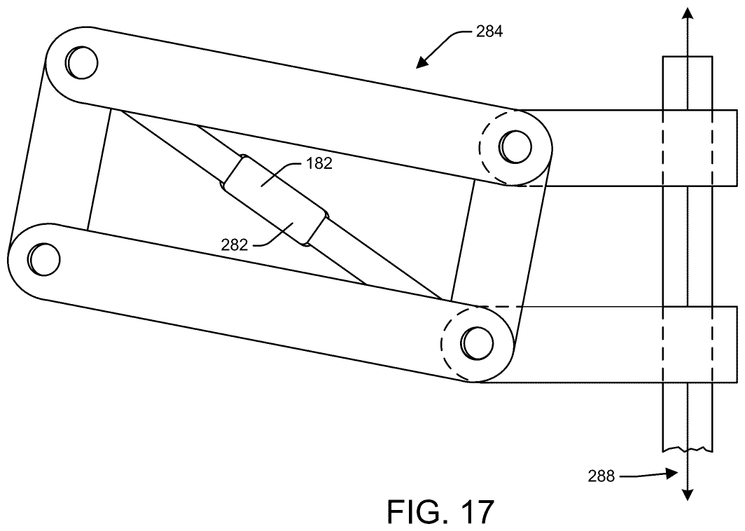

As shown in FIGS. 1A, 4, 5 and 8, the first deck 200 further comprises a first deck caster 286 operationally engaged therewith. As is typical of casters, each caster herein, e.g., first deck caster 286, second deck caster 386, third caster 586, is a rotatable wheel mounted to rotate about a caster axis that is offset from a caster swivel axis by some caster lag distance such that, in operation, the caster will self-align to the direction of travel. Accordingly, the first deck caster 286 is operationally engaged with the first deck 200 to be pivotable about a first deck caster swivel axis 288. In the aspect shown in the latter referenced FIGS, first deck caster 286 is operationally engaged with the first deck 200 proximate to the first deck front 234. First deck caster 286 is adapted to contribute to support of the first deck 200 at some desired distance above the surface 40 to be mowed during a mowing operation. As shown in FIGS. 1, 1A, 4, 5 and 17 first deck caster 286 is engaged to the first deck by a first deck caster parallelogram linkage 284 such that the first deck caster swivel axis 288 may move with respect to the first deck between different positions in order to adjust the desired distance above the surface 40 at which the first deck caster 286 supports the first deck 200. It should be understood that by nature of the first deck caster parallelogram linkage 284 being a parallelogram linkage, the orientation of the first deck caster swivel axis 288 is substantially fixed with respect to the first deck 200 and does not change with respect to the first deck 200 as its position changes. In some embodiments, the parallelogram linkage may comprise a caster biasing spring 182 operationally engaged therewith to provide force on the first deck 200 to bias the deck upwardly with respect to the surface 40. The caster biasing spring 182 may optionally be chosen with good engineering judgment to have such properties as to act as a component of a passive height adjustment mower suspension 110, aspects of which are described more fully below, which will contribute to hold the first deck 200 at a desired distance above the surface 40 without active adjustment. In some optional embodiments the caster biasing spring 182 may work in conjunction with a damper (not shown) chosen with good engineering judgment, such as a shock-absorber, and adapted to reduce, minimize, or eliminate bouncing, vibration, or oscillation. In other acceptable optional aspects, the position of the first deck caster swivel axis 288 may be actively adjusted by an active height adjustment mower suspension 130, aspects of which are described more fully below, in order to adjust the desired distance above the surface 40 at which the first deck caster 286 supports the first deck 200.

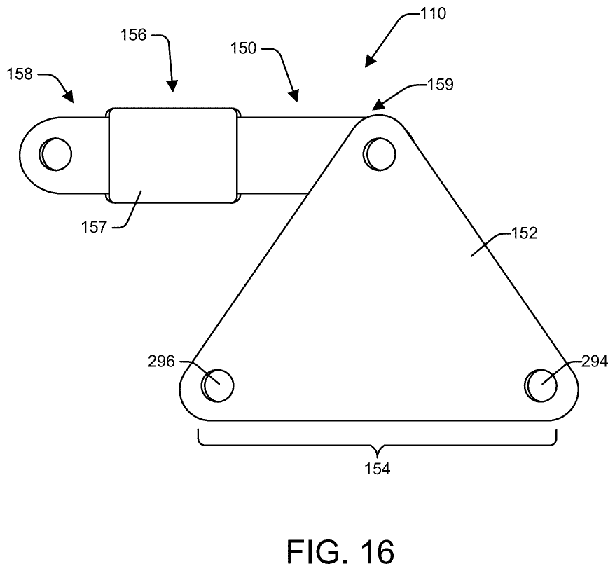

As shown in FIGS. 4, and 5, 8, 8A and 16 the first deck 200 may further comprise a first rear support roller 290 operationally engaged therewith. The first rear support roller 290, is a rotatable wheel mounted to rotate about a first rear support roller axis 294 that may be substantially parallel to the width direction. Herein, substantially parallel means that the axes in question are within an operationally trivial spatial range from parallel. Here it is to be understood that operationally trivial means that any deviation from the nominal orientation does not adversely affect the quality of the mowing operation in a way that is deemed important using good engineering judgment. In some aspects, that operationally trivial amount is no more than 4 mm or 4 degrees from the nominal parallel position and orientation. In some aspects, that operationally trivial amount is no more than 2 mm or 2 degrees from the nominally parallel position and orientation. In some aspects, that operationally trivial amount is no more than 1 mm or 1 degree from the nominally parallel position and orientation. In the aspect shown in the latter referenced FIGS, first rear support roller 290 is operationally engaged with the first deck 200 proximate to the first deck back 246. First rear support roller 290 is adapted to contribute to support of the first deck 200 at some desired distance above the surface 40 to be mowed during a mowing operation. As shown in the FIGS, first rear support roller 290 is adjustably engaged to the first deck 200 such that the first rear support roller 290 may move with respect to the first deck 200 between different positions in order to adjust the desired distance above the surface 40 at which the first rear support roller 290 supports the first deck 200. In some embodiments, the orientation of the first rear support roller axis 294 is substantially fixed with respect to the first deck 200 and does not change with respect to the first deck 200 as its position changes. This later operation to change position of the first rear support roller axis 294 without change of orientation of the first rear support roller axis 294 may be accomplished by any means chosen with good engineering judgment such as, and without limitation, by rotation of the first rear support roller axis 294 about a first height adjustment axis 296 that is substantially fixed in position and orientation with respect to the first deck. In some embodiments, the first rear support roller 290 may be operationally engaged with a first rear support roller biasing spring 298 operationally engaged therewith to provide force on the first deck 200 to bias the deck upwardly with respect to the surface 40. The first rear support roller biasing spring 298 may be chosen with good engineering judgment to have such properties as to act as a component of a passive height adjustment mower suspension 110, aspects of which are described more fully below, which will contribute to hold the first deck 200 at a desired distance above the surface 40 without active adjustment. In some embodiments the first rear support roller biasing spring 298 may work in conjunction with a damper (not shown) chosen with good engineering judgment, such as a shock-absorber, and adapted to reduce, minimize, or eliminate bouncing, vibration, or oscillation. In another acceptable aspect, the position of the first rear support roller 290 may be actively adjusted by an active height adjustment mower suspension 130, aspects of which are described more fully below, in order to adjust the desired distance above the surface 40 at which the first rear support roller 290 supports the first deck 200.

In certain aspects, the above-referenced passive height adjustment mower suspension 110 comprises a mower deck, such as and without limitation first deck 200, second deck 300, or third deck 500, the mower deck having an operationally engaged mower blade, such as and without limitation first blade 262, or second blade 362, or third blade 562, or an operationally engaged mower blade set, such as and without limitation first blade set 260, or second blade set 360, or third blade set 560. The above-referenced passive height adjustment mower suspension 110 further comprises a passive suspension slider-crank mechanism 150 engaged with the mower deck. The passive suspension slider-crank mechanism 150 further comprises a passive suspension crank 152 defining a height adjustment axis, such as and without limitation, first height adjustment axis 296, about which the passive suspension crank 152 is rotatably mounted to the mower deck, and a roller axis, such as and without limitation, first rear support roller axis 294, offset from the height adjustment axis by a passive suspension fixed adjustment distance 154. The passive suspension slider-crank mechanism 150 further comprises a passive suspension slider 156 defined by a slider spring 157. The slider spring 157 has a first slider spring end 158 operatively engaged to the mower deck, and a second slider spring end 159 operatively engaged to the passive suspension crank 152 to passively output energy stored in the slider spring 157 to rotate the passive suspension crank 152 about the height adjustment axis. In operation of the passive height adjustment mower suspension 110, rotation of the passive suspension crank 152 about the height adjustment axis changes the position of the roller axis with respect to the mower deck. It should be understood that the passive height adjust mower suspension 110 described above will support the mower deck, optionally first deck 200, at some desired height during operations and that in response to upward forces from one or more other operationally engaged decks, optionally second deck 300, or third deck 500, or both, will support the mower deck at an increased height. It should further be understood that the passive height adjust mower suspension 110 described above will support the mower deck, optionally first deck 200, at some desired height during operations and that in response to downward forces from one or more other operationally engaged decks, optionally second deck 300, or third deck 500, or both, will support the mower deck at an decreased height. Accordingly, the passive height adjust mower suspension 110 described above will support the mower deck, optionally first deck 200, at a height that may be adjusted by adjusting the height of one or more other operationally engaged decks, optionally second deck 300, or third deck 500, or both.

In some optional aspects of the latter passive height adjustment mower suspension 110, the height adjustment axis is substantially parallel with the roller axis. Some optional aspects of the latter passive height adjustment mower suspension 110 may further comprise a support roller, optionally first rear support roller 290, operatively engaged with the roller axis to rotate thereabout when in operation. As noted above, the support roller is adapted to operate to support the mower deck above a surface when the mower deck is in motion. Some optional aspects of the latter passive height adjustment mower suspension 110 may further comprise a caster, optionally first deck caster 286, adapted to support the mower deck above the surface. In some optional aspects of the latter passive height adjustment mower suspension 110, the caster, optionally first deck caster 286, is movably engaged to the mower deck, optionally first deck 200, through a caster parallelogram linkage, optionally, first deck caster parallelogram linkage 284. As noted above, a caster parallelogram linkage may be adapted to move the caster with respect to the mower deck between different positions in order to adjust distance above the surface at which the caster supports the mower deck. In some optional aspects of the latter passive height adjustment mower suspension 110, the caster parallelogram linkage is operationally engaged with a caster biasing spring, optionally first deck caster biasing spring 182 such that the caster biasing spring is adapted to passively adjust the distance above the surface at which the caster supports the deck.

With continued reference to FIG. 1, and with further reference to FIGS. 1A, 1B, 1E, 6 and 7, articulated mower apparatus 100 comprises a second deck 300. Second deck 300 is a mower deck and may approximate a flat box that is generally rectangular or trapezoidal in shape.

Second deck 300 is operationally engaged with the first deck 200 at one side of the first deck 200, either the first deck right side 224 or the first deck left side 226, by a first linkage 400. The first linkage 400 defines a first articulation axis 410 and is adapted to permit the second deck 300 to rotate about the first articulation axis 410 with respect to the first deck 200. The first linkage 400 may take any of a variety of acceptable forms including a first hinge 420 or a four-bar mechanism, or a gimbal, or otherwise as chosen with good engineering judgment. It should be understood that where the first linkage is a hinge 420 the first articulation axis 410 will be fixed in position and orientation with respect to the first deck 200 but this is not limiting and in other acceptable embodiments, the linkage may define an instantaneous first articulation axis that moves in position with respect to the first deck 200. For example, and not limitation, a first linkage 400 that is a four-bar mechanism may define an instantaneous first articulation axis that moves in position with respect to the first deck 200. In some embodiments, first articulation axis 410 is substantially parallel to the depth direction 230.

As shown in FIGS. 4, 6, 7, and 8, the second deck 300 comprises a second blade 362 rotatably engaged with the second deck 300 and adapted to perform or contribute to a mowing operation on a surface 40. The second blade 362 is part of a second blade set 360 comprising, in addition to second blade 362, another zero, one, two or more additional blades. The second blade 362 may be operationally engaged with a second deck mow head 364 which is adapted to rotate the second blade 362, and the second blade set 360, at speeds appropriate to a mowing operation around a second blade operational axis 368. When so rotated at speeds appropriate to a mowing operation around a second blade operational axis 368, the second blade 362 may be operated to perform a mowing operation or to contribute to a mowing operation along the surface 40 with one or more other blades, for example but not limitation, a first blade or third blade, similarly in an operational state. As referenced above, the second deck mow head 364, defines the second blade operational axis 368, about which the operationally engaged second blade 362 rotates during a mowing operation. As referenced above, the second mow head 364 may have its own local electrical motor to provide the work to operate the second blade 362, but this is not limiting, and the work to operate the blade could alternatively come from any of the alternatives referenced above. The second deck mow head 364 is substantially fixed with respect to the second deck 300. Accordingly, the second blade operational axis 368 defined by the second deck mow head 364 is similarly substantially fixed with respect to the second deck 300.

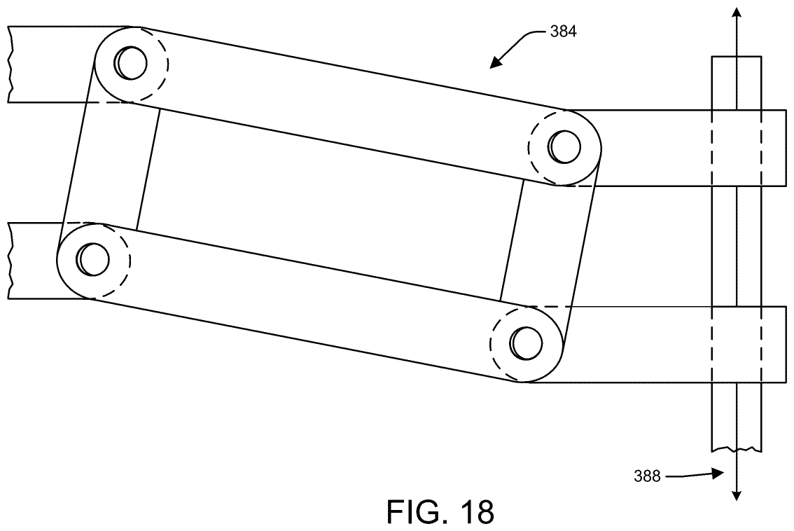

As shown in FIGS. 1A and 18 the second deck 300 further comprises a second deck caster 386 operationally engaged therewith. As referenced above, second deck caster 386 is a rotatable wheel mounted to rotate about a caster axis that is offset from a second deck caster swivel axis 388 by some caster lag distance such that, in operation, the second deck caster 386 will self-align to the direction of travel. Accordingly, the second deck caster 386 is operationally engaged with the second deck 300 to be pivotable about a second deck caster swivel axis 388. In the aspect shown in the latter referenced FIGS, second deck caster 386 is operationally engaged with the second deck 300 proximate to a second deck front 334. Second deck caster 386 is adapted to contribute to support of the second deck 300 at some desired distance above the surface 40 to be mowed during a mowing operation. As shown in FIGS. 1A and 18 second deck caster 386 is engaged to the second deck 300 by a second deck caster parallelogram linkage 384 such that the second deck caster swivel axis 388 may move with respect to the second deck 300 between different positions in order to adjust the desired distance above the surface 40 at which the second deck caster 386 supports the second deck 300. Similar to the situation above with respect to the first caster parallelogram linkage, because the second deck caster parallelogram linkage 384 is a parallelogram linkage, the orientation of the second deck caster swivel axis 388 is substantially fixed with respect to the second deck 300 and does not change with respect to the second deck 300 as its position changes. In some embodiments, the second deck caster parallelogram linkage 384 and second deck caster 386 may be actively adjusted by an active height adjustment mower suspension 130, aspects of which are described more fully below, in order to adjust the desired distance above the surface 40 at which the second deck caster 386 supports the second deck 300.

As shown in FIGS. 1 and 4, the second deck 300 further comprises a second deck drive roller 390. The second deck drive roller 390 is rotatably engaged with the second deck about a second deck drive axis 394. The second deck drive axis 394 is substantially fixed in orientation with respect to the second deck. The second deck drive roller 390 is adapted to support the second deck above the surface 40 and is further adapted to output work to the surface 40 to promote motion of the articulated mower apparatus over the surface 40. In some aspects, the operational position of the second deck drive axis 394 may be adjusted while maintaining its substantially fixed orientation by moving the second deck drive axis 394 to one or more other positions having orientation parallel to one another. One way to accomplish this latter adjustment of second deck drive axis 394 is by rotating the second deck drive axis 394 about a second height adjustment axis 396 offset from, and substantially parallel to, the second deck drive axis 394. In conjunction with the above aspect of a second deck caster 386 that is adjustable in height without change in orientation, the latter provided adjustment of second deck drive axis 394, it should be understood that some aspects of the present subject matter permit the mow height of the second deck 300 to be adjusted while still maintaining the same orientation with respect to the second deck 300 of supporting second deck caster 386 and second deck drive roller 390. In some embodiments, the second deck drive axis 394 may be operationally engaged with an active height adjustment mower suspension 130, described more fully below, adapted to rotate the second deck drive axis 394 about the second height adjustment axis 396 in order to actively adjust the desired distance above the surface 40 at which the second deck drive roller 390 supports the second deck 300.

It should be understood that the second blade 362, the second deck mow head 364, the second blade operational axis 368, the second deck caster 386, the second deck drive roller 390, the second deck drive axis, and other components substantially fixed with respect to the second deck are adapted to rotate with the second deck 300 about the first articulation axis 410 with respect to the first deck 200 as the second deck 300 rotates about the first articulation axis 410 with respect to the first deck 200.

With continued reference to FIG. 1, and with further reference to FIGS. 1B, IC, 7, 8, and 12, articulated mower apparatus 100 may further comprise a third deck 500. Third deck 500 is a mower deck and may approximate a flat box that is generally rectangular or trapezoidal in shape.

Third deck 500 is operationally engaged with the first deck 200 at one side of the first deck 200, either the first deck right side 224 or the first deck left side 226, opposite the second deck 300. Third deck 500 is operationally engaged to the first deck 300 by a second linkage 600. The second linkage 600 defines a second articulation axis 610 and is adapted to permit the third deck 500 to rotate about the second articulation axis 610 with respect to the first deck 200. The second linkage 600 may take any of a variety of acceptable forms including a second hinge 620 or a four-bar mechanism, or a gimbal, or otherwise as chosen with good engineering judgment. It should be understood that where the second linkage 600 is a hinge 620 the second articulation axis 610 will be fixed in position and orientation with respect to the first deck 200 but this is not limiting and in other acceptable embodiments, the second linkage 600 may define an instantaneous second articulation axis that moves in position with respect to the first deck 200. For example, and not limitation, a second linkage 600 that is a four-bar mechanism may define an instantaneous second articulation axis that moves in position with respect to the first deck 200. In some embodiments, the second articulation axis 610 is substantially parallel to the first articulation axis 410 or is substantially parallel to the depth direction 230 or is substantially parallel to both.

As shown in FIGS, the third deck 500 comprises a third blade 562 rotatably engaged with the third deck 500 and adapted to perform or contribute to a mowing operation on a surface 40. The third blade 562 is part of a third blade set 560 comprising, in addition to third blade 562, another zero, one, two or more additional blades. The third blade 562 may be operationally engaged with a third deck mow head 564 which is adapted to rotate the third blade 562, and the third blade set 560, at speeds appropriate to a mowing operation around a third blade operational axis 568. When so rotated at speeds appropriate to a mowing operation around a third blade operational axis 568, the third blade 562 may be operated to perform a mowing operation or to contribute to a mowing operation along with one or more other blades, for example but not limitation, a first blade or second blade, similarly in an operational state. As referenced above, the third deck mow head 564, defines the third blade operational axis 568, about which the operationally engaged third blade 562 rotates during a mowing operation. As referenced above, the third mow head 564 may have its own local electrical motor to provide the work to operate the third blade 562, but this is not limiting, and the work to operate the blade could alternatively come from any of the alternatives referenced above. The third deck mow head 564 is substantially fixed with respect to the third deck 500. Accordingly, the third blade operational axis 568, defined by the third deck mow head 564, is similarly substantially fixed with respect to the third deck 500.

As shown in FIGS. 1B, 5B, 6, and 8, the third deck 500 further comprises a third deck caster 586 operationally engaged therewith. As referenced above, third deck caster 586 is a rotatable wheel mounted to rotate about a caster axis that is offset from a third deck caster swivel axis 588 by some caster lag distance such that, in operation, the third deck caster 586 will self-align to the direction of travel. Accordingly, the third deck caster 586 is operationally engaged with the third deck 500 to be pivotable about a third deck caster swivel axis 588. In the aspect shown in the latter referenced FIGS, third deck caster 586 is operationally engaged with the third deck 500 proximate to a third deck front 534. Third deck caster 586 is adapted to contribute to support of the third deck 500 at some desired distance above the surface 40 to be mowed during a mowing operation. As shown in FIGS. 1B, 5B, 6, and 8, third deck caster 586 is engaged to the third deck 500 by a third deck caster parallelogram linkage 584 such that the third deck caster swivel axis 588 may move with respect to the third deck 500 between different positions in order to adjust the desired distance above the surface 40 at which the third deck caster 586 supports the third deck 500. Similar to the situation above with respect to the first caster parallelogram linkage, because the third deck caster parallelogram linkage 584 is a parallelogram linkage, the orientation of the third deck caster swivel axis 588 is substantially fixed with respect to the third deck 500 and does not change with respect to the third deck 500 as its position changes. In some embodiments, the third deck caster parallelogram linkage 584 may be operationally engaged with an actuator adapted to actively adjust the desired distance above the surface 40 at which the third deck caster 586 supports the third deck 500. In some non-limiting embodiments, the latter actuator adapted to actively adjust the desired distance above the surface 40, at which the third deck caster 586 supports the third deck 500, is third deck actuator 512.

As shown in FIGS. 1B, 5B, 6, and 8, the third deck 500 further comprises a third deck drive roller 590. The third deck drive roller 590 is rotatably engaged with the third deck 500 about a third deck drive axis 594. The third deck drive axis 594 is substantially fixed in orientation with respect to the third deck 500. The third deck drive roller 590 is adapted to support the third deck 500 above the surface 40, and is further adapted to output work to the surface 40 to promote motion of the articulated mower apparatus over the surface 40. In some aspects, the operational position of the third deck drive axis 594 may be adjusted while maintaining its substantially fixed orientation by moving the third deck drive axis 594 to one or more other positions having orientation parallel to one another. One way to accomplish this latter adjustment of third deck drive axis 594 is by rotating the third deck drive axis 594 about a third height adjustment axis 596 offset from and substantially parallel to the third deck drive axis 594. In conjunction with the above aspect of a third deck caster 586 that is adjustable in height without change in orientation, the latter provided adjustment of third deck drive axis 594, it should be understood that some aspects of the present subject matter permit the mow height of the third deck 500 to be adjusted while still maintaining the same orientation with respect to the second deck 500 of supporting third deck caster 586 and third deck drive roller 590. In some embodiments, the third deck drive axis 594 may be operationally engaged with an active height adjustment mower suspension 130, described more fully below, adapted to rotate the third deck drive axis 594 about the third height adjustment axis 596 in order to actively adjust the desired distance above the surface 40 at which the third deck drive roller 590 supports the third deck 500.

It should be understood that the third blade 562, the third deck mow head 564, the third blade operational axis 568, the third deck caster 586, the third deck drive roller 590, the third deck drive axis 594, and other components substantially fixed with respect to the third deck 500, are adapted to rotate with the third deck 500 about the second articulation axis 610 with respect to the first deck 200 as the third deck 500 rotates about the second articulation axis 610 with respect to the first deck 200.

In certain aspects, the above-referenced active height adjustment mower suspension 130 comprises a mower deck, optionally second deck 300 or third deck 500, having an operationally engaged mower blade, optionally second blade 362 or third blade 562, or mower blade set, optionally second blade set 360, or third blade set 560. The above-referenced active height adjustment mower suspension 130 further comprises an active suspension slider-crank mechanism 160 engaged with the mower deck. The active suspension slider-crank mechanism 160 further comprises an active suspension crank 162 defining a height adjustment axis, optionally second deck height adjustment axis 396, or third deck height adjustment axis 596, about which the active suspension crank 162 is rotatably mounted to the mower deck, and a drive axis, optionally second deck drive axis 394 or third deck drive axis 594, offset from the height adjustment axis by an active suspension fixed adjustment distance 164. The active suspension slider-crank mechanism 160 further comprises an active suspension slider 166 defined by a linear actuator 167, optionally second deck actuator 312 or third deck actuator 512. The linear actuator has a first actuator end 168 operatively engaged to the mower deck, and a second actuator end 169 operatively engaged to the crank to transmit work to rotate the crank about the height adjustment axis. In operation of the active height adjustment mower suspension 130, rotation of the active suspension crank 162 about the height adjustment axis changes the position of the drive axis with respect to the mower deck. It should be understood that the linear actuator will be selectably controlled by an associated operator.

In some optional aspects of the latter active height adjustment mower suspension 130, the height adjustment axis is substantially parallel with the drive axis. In some optional aspects of the latter active height adjustment mower suspension 130, further comprises a drive roller, optionally second deck drive roller 390 or third deck drive roller 590, operatively engaged with the drive axis to rotate thereabout when in operation, the drive wheel being adapted to operate to apply work between a surface and the mower deck to promote motion of the mower deck with respect to the surface, and support the mower deck above the surface when in motion. In some optional aspects of the latter active height adjustment mower suspension 130, further comprises a caster, optionally second deck caster 386 or third deck caster 586, adapted to support the mower deck above the surface. In some optional aspects of the latter active height adjustment mower suspension 130, the caster is movably engaged to the mower deck through a caster parallelogram linkage, optionally second deck caster parallelogram linkage 384 or third deck caster parallelogram linkage 584, the caster parallelogram linkage being adapted to move the caster with respect to the mower deck between different positions in order to adjust distance above the surface at which the caster supports the mower deck. In some optional aspects of the latter active height adjustment mower suspension 130, the caster parallelogram linkage is operationally engaged with the actuator, optionally second deck actuator 312 or third deck actuator 512, such that the actuator is adapted to actively adjust the distance above the surface at which the caster supports the deck.

It should be understood that some aspects of the above disclosed apparatus provide an articulated mowing apparatus 100 in which the support wheels or rollers, collectively an articulated drive system 150, are adapted to comply with contoured ground. That is, the second deck 300 is articulated with respect to the first deck 200 at first articulation axis 410. Because of this latter articulation, second deck 200 may comply with the contoured ground defined by surface 40 being mowed. For example, a small hill in the surface 40, local to the second deck 300, will cause second deck 300 to rise up and rotate with respect to the first deck 200 as the articulated mowing apparatus 100 moves over the hill. A second deck drive roller 390 that is fixed in orientation with respect to the second deck 300, as provided in some of the above aspects, will likewise comply with the countered ground defined by surface 40 being mowed as the second deck 200 does so. It should be noted that because the above aspects permit the mow height of the second deck 300 to be adjusted while still maintaining the same orientation with respect to the second deck 300 of supporting second deck caster 386 and second deck drive roller 390, this performance capability of a drive roller that will comply with contoured ground is consistently available at any provided mow height. These latter performance characteristics of the second deck 300 are similarly true with respect to the third deck 500. It should further be understood that this performance capability of a drive roller that will comply with contoured ground is optimal where the relevant axis of articulation, e.g. first articulation axis 410 or second articulation axis 610, is substantially parallel to the depth direction 230, but some deviation of the articulation axis or axes from orientations that are substantially parallel to the depth direction 230 may be acceptable if the change from optimal performance is also acceptable according to good engineering judgment, and such aspects are part of the present subject matter.

In certain aspects, the above referenced articulated drive system 150 comprises second drive roller 390 or the third deck drive roller 590 or both and optionally one or more casters. Generally, the second deck drive roller 390 is adapted to apply work between a surface 40 and the second deck 300 to promote motion of the second deck 300 with respect to the surface 40. Because the second deck drive axis 394 is adjustable in position but fixed in orientation, it should be understood that the second deck drive axis 394 and the first articulation axis 410 may be either i) perpendicular to one another or ii) mutually orthogonal to a common perpendicular vector. Also, in at least some aspects, the second drive roller 390 provides some or all of the work to move the second deck 300 and the first deck 200. As such, the first linkage 400 may be adapted to provide sufficient structural integrity to transmit sufficient work between the second deck 300 to the first deck 200 to move the first deck 200 and the second deck 300 over the surface during a mowing operation. Alternatively, or in addition to a first linkage 400 that is adapted to provide sufficient structural integrity to transmit sufficient work between the second deck to the first deck to move the first deck 200 and the second deck 300 over the surface 40 during a mowing operation, the second deck 300 may provide means to push the first deck 200, such as, and without limitation, a bumper or spring. Similarly, in some embodiments, the third deck drive roller 590 is adapted to apply work between a surface 40 and the third deck 500 to promote motion of the third deck 500 with respect to the surface 40. Because the third deck drive axis 594 is adjustable in position but fixed in orientation, it should be understood that the third deck drive axis 594 and the second articulation axis 610 may be either i) perpendicular to one another or ii) mutually orthogonal to a common perpendicular vector. Also, in at least some aspects, the third drive roller 590 provides some or all of the work to move the third deck 500 and the first deck 200. As such, the second linkage 600 may be adapted to provide sufficient structural integrity to transmit sufficient work between the third deck 500 to the first deck 200 to move the first deck 200 and the third deck 500 over the surface during a mowing operation. Alternatively, or in addition to a second linkage 600 that is adapted to provide sufficient structural integrity to transmit sufficient work between the third deck 500 to the first deck 200 to move the first deck 200 and the third deck 500 over the surface 40 during a mowing operation, the third deck 500 may provide means to push the first deck 200, such as, and without limitation, a bumper or spring.

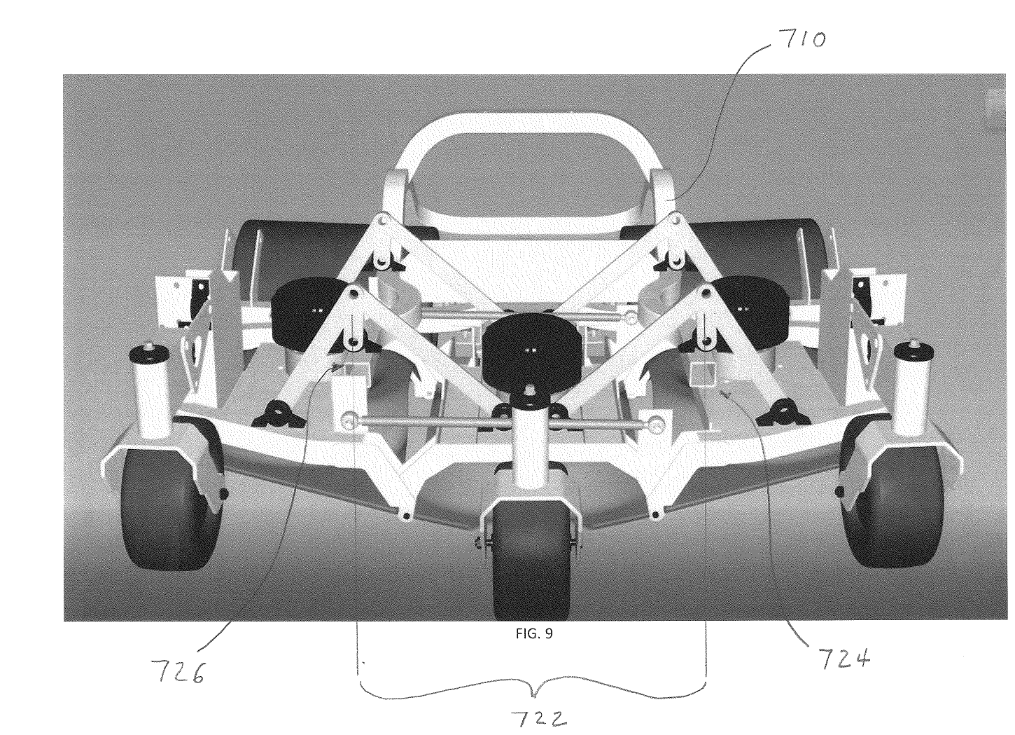

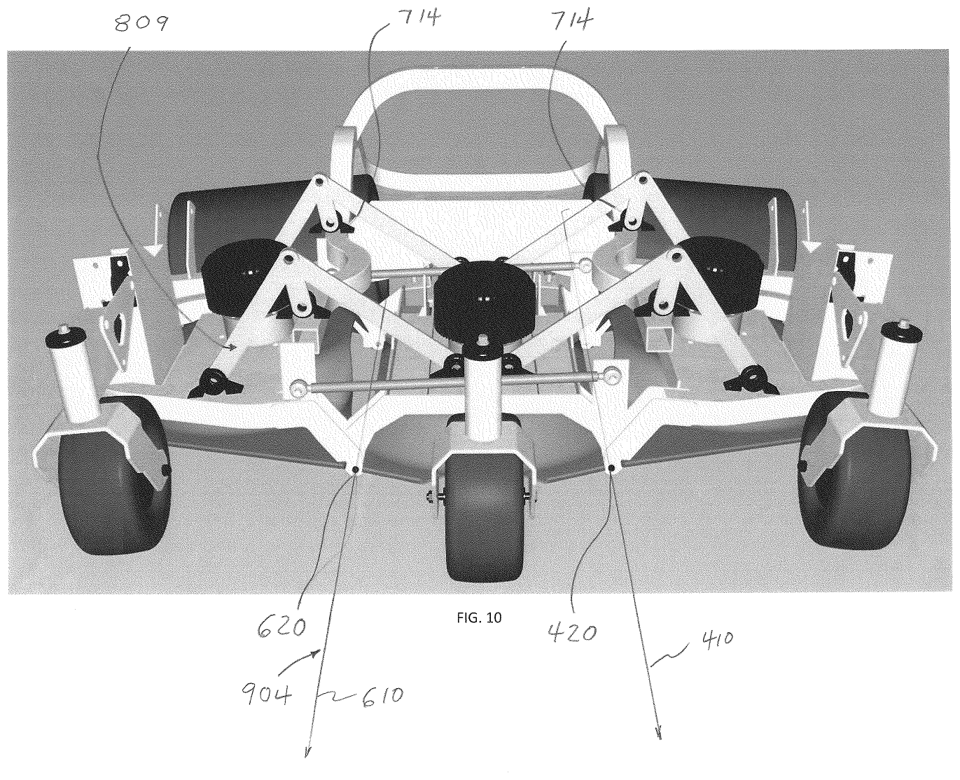

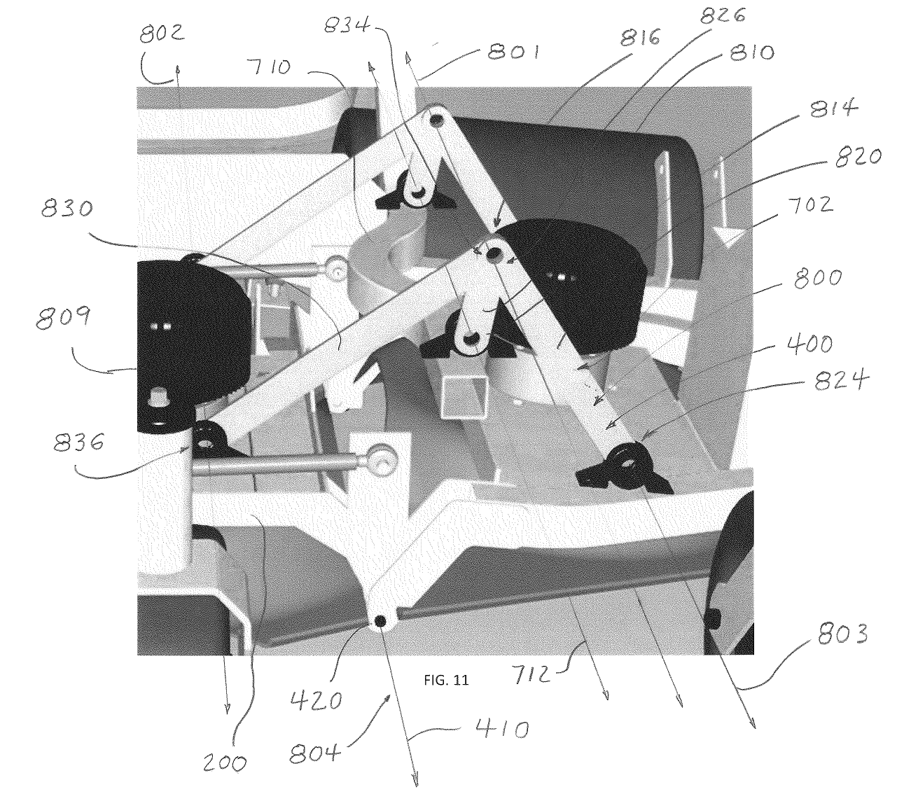

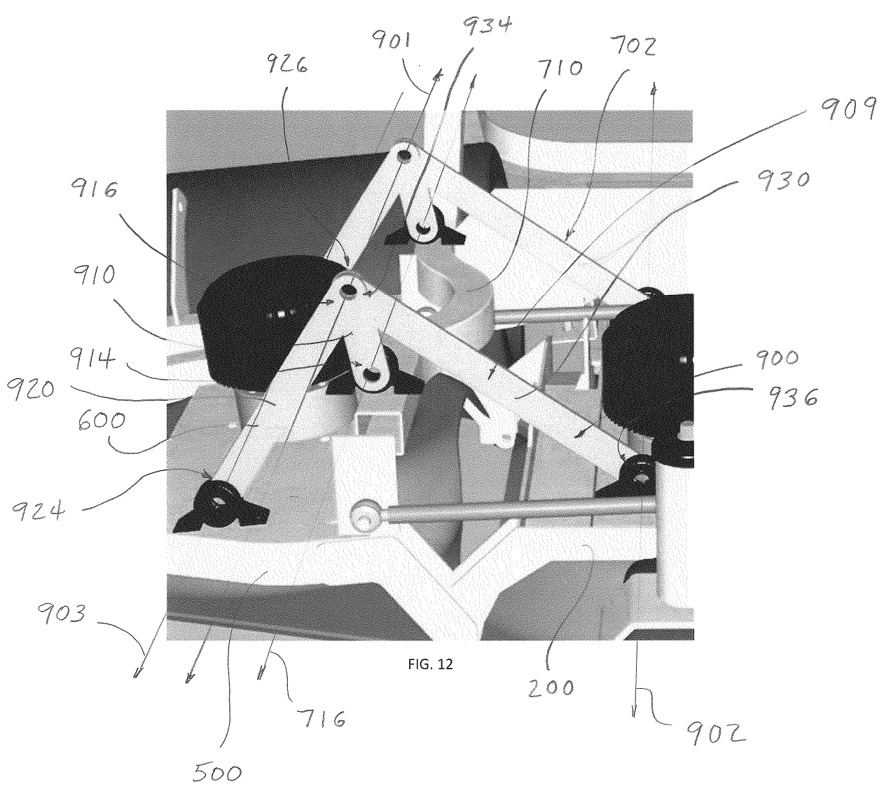

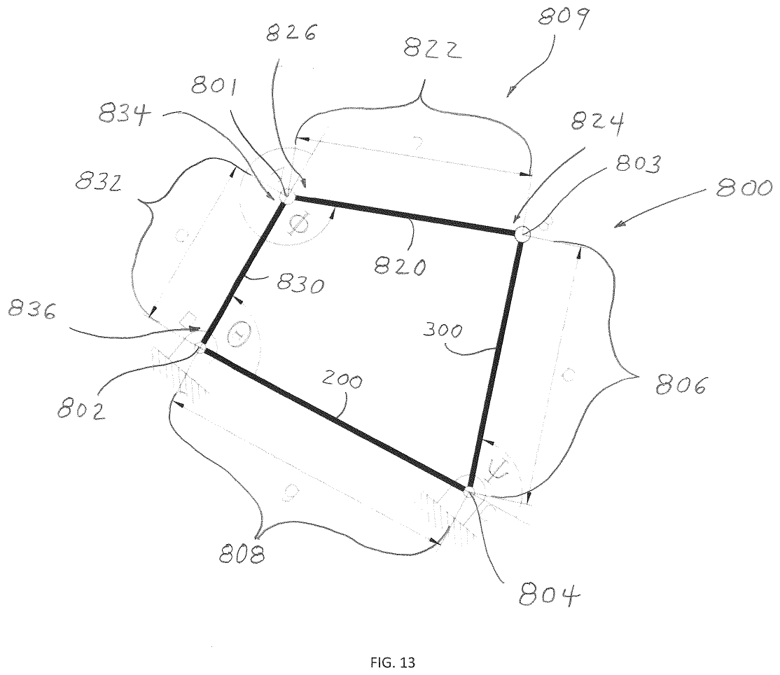

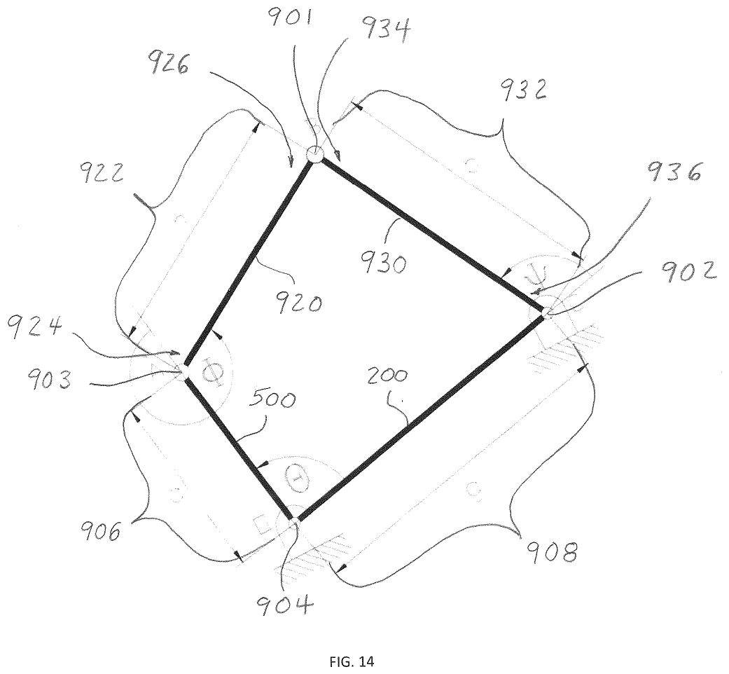

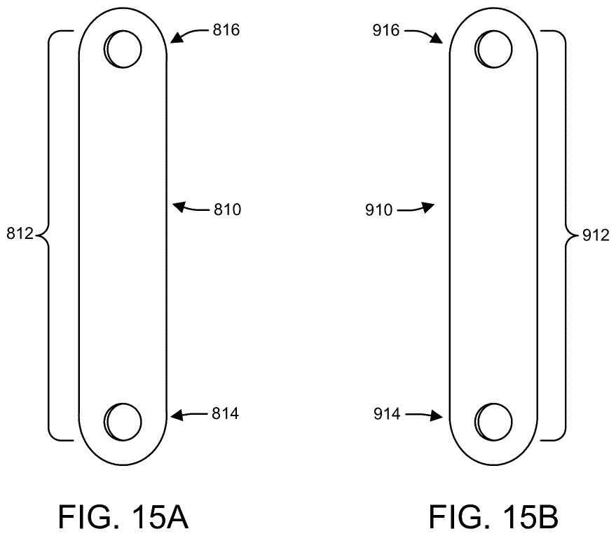

With further reference now to FIGS. 9-14, the provided articulated mower apparatus 100 may include, in addition to a plurality of decks and the articulated drive system 150 described above, which may be referred to collectively as a movably combined mower subframe 160, a mower operation platform 700. Operation platform 700 may comprise an operator frame 710 supported by one or more of the decks, first deck 200 or second deck 300, or third deck 500, or some combination thereof, through at least one support element 702. Operator frame 710 has an operator frame first side 724 and an operator frame second side 726 opposite from the operator frame first side 724 and offset in a width direction 220 by an operator frame width 722. Operator frame 710 has an operator frame front 734 and an operator frame back 736 opposite from the operator frame front 734 and offset in a depth direction 230 by an operator frame depth 732. Operator frame 710 has an operator frame top 744 and an operator frame bottom 746 opposite the operator frame top 744 and offset in a height direction 240 by an operator frame height 742.

In some aspects, one or more support elements 702 may fixedly secure the operator frame 710 to a deck of the movably combined mower subframe 160. In other embodiments, the one or more support elements 702 may secure the operator frame 710 to the movably combined mower subframe 160 while permitting the operator frame 710 some freedom to move, or rotate, or both as one or more components of the movably combined mower subframe 160 move or rotate.

In some aspects, the one or more support elements 702 comprises at least a first operation platform linkage 800 rotatably engaged between the operator frame 710 and the first deck 200. The operator frame 710 may further comprise at least a first operator frame pivot axis 712 defined by one or more rotatable connection elements 714, such as and without limitation, a frictionless bearing, or a bushing, or a sleeve bearing, or journal bearing, or otherwise as chosen with good engineering judgment, operationally engaged with at least one side of the operator frame 710, such as operator frame first side 724 or operator frame second side 726. The first operation platform linkage 800 may comprise a first operator frame support link 810 elongated to define a first operator frame support link bottom end 814 and a first operator frame support link top end 816 opposite from the first operator frame support link bottom end 814 and offset therefrom by a first operator frame support link length 812 that is substantially fixed, the first operator frame support link bottom end 814 being rotatably engaged with the operator frame 710 through one or more rotatable connection elements 714, to rotate about the first operator frame pivot axis 712. The first operation platform linkage 800 may comprise a first connector link 820 elongated to define a first connector link input end 824 and a first connector link output end 826 opposite from the first connector link input end 824 and offset therefrom by a first connector link length 822 that is substantially fixed, the first connector link output end 826 being rotatably engaged with the first operator frame support link top end 816 to rotate about a first operation platform linkage connector-output axis 801. The first operation platform linkage 800 may comprise a first output link 830 elongated to define a first output link connector end 834 and a first output link ground end 836 opposite from the first output link connector end 834 and offset therefrom by a first output link length 832 that is substantially fixed, the first output link connector end 834 being rotatably engaged with the first connector link output end 826 to rotate about the first operation platform linkage connector-output axis 801. The first output link ground end 836 may be rotatably engaged with the first deck 200 to rotate about a first operation platform linkage output-ground axis 802. The first operation platform linkage output-ground axis 802 may be substantially fixed with respect to the first deck 200. The operation platform 700, may further comprise a second deck 300 engaged to the first deck 200 by a first hinge 420 adapted to define a first articulation axis 410 about which the second deck 300 can rotate with respect to the first deck 200. The second deck 300 may be supported by one or more wheels or rollers, such as and without limitation, second deck caster 386, or second deck drive roller 390, and may have an operationally engaged mower blade, such as second blade 362. The first connector link input end 824 may be rotatably engaged with the second deck 300 to rotate about a first operation platform linkage input-connector axis 803. The first operation platform linkage input-connector axis 803 may be substantially fixed with respect to the second deck 300. The first operation platform linkage input-connector axis 803 may be offset from the first articulation axis 410 by a first input link length 806 that is substantially fixed. The first operation platform linkage output-ground axis 802 may be offset from the first articulation axis 410 by a first ground link length 808 that is substantially fixed. In the non-limiting embodiment shown in the FIGS., first operator frame pivot axis 712, first operation platform linkage output-ground axis 802, and first operation platform linkage input-connector axis 803, are each defined by a plurality of coaxially aligned rotatable connection elements 714 fixed to the operator frame 710, the second deck 300 and the first deck 200, respectively.

In some aspects of the foregoing, it should be understood that the first connector link 820, the first output link 830, the first deck 200, and the second deck 300 may be operationally engaged so that the first operation platform linkage 800 defines a first planar quadrilateral linkage 809. In some aspects of the foregoing, it should be understood that the first operator frame pivot axis 712, the first operation platform linkage connector-output axis 801, the first operation platform linkage output-ground axis 802, and the first operation platform linkage input-connector axis 803 may be each substantially parallel to one another. In some aspects of the foregoing, it should be understood that the first operator frame pivot axis 712, the first operation platform linkage connector-output axis 801, the first operation platform linkage output-ground axis 802, and the first operation platform linkage input-connector axis 803 may be each substantially parallel to the depth direction 230. Further to the above, then, it should be understood that the first articulation axis 410 may act as a first ground-input axis 804 in the above described first planar quadrilateral linkage 809.

In some aspects, the one or more support elements 702 comprises at least a second operation platform linkage 900 rotatably engaged between the operator frame 710 and the first deck 200. The operator frame 710 may further comprise at least a second operator frame pivot axis 716 defined by one or more rotatable connection elements 714 operationally engaged with at least one side of the operator frame 710, such as operator frame first side 724 or operator frame second side 726 and on the opposite side from that of the first operator frame pivot axis 712. The second operation platform linkage 900 may comprise a second operator frame support link 910 elongated to define a second operator frame support link bottom end 914 and a second operator frame support link top end 916 opposite from the second operator frame support link bottom end 914 and offset therefrom by a second operator frame support link length 912 that is substantially fixed, the second operator frame support link bottom end 914 being rotatably engaged with the operator frame 710 through the one or more rotatable connection elements 714 to rotate about the second operator frame pivot axis 716. The second operation platform linkage 900 may comprise a second connector link 920 elongated to define a second connector link input end 924 and a second connector link output end 926 opposite from the second connector link input end 924 and offset therefrom by a second connector link length 922 that is substantially fixed, the second connector link output end 926 being rotatably engaged with the second operator frame support link top end 916 to rotate about a second operation platform linkage connector-output axis 901. The second operation platform linkage 900 may comprise a second output link 930 elongated to define a second output link connector end 934 and a second output link ground end 936 opposite from the second output link connector end 934 and offset therefrom by a second output link length 932 that is substantially fixed, the second output link connector end 934 being rotatably engaged with the second connector link output end 926 to rotate about the second operation platform linkage connector-output axis 901. The second output link ground end 936 may be rotatably engaged with the first deck 200 to rotate about a second operation platform linkage output-ground axis 902. The second operation platform linkage output-ground axis 902 may be substantially fixed with respect to the first deck 200. The operation platform 700, may further comprise a third deck 500 engaged to the first deck 200 by a second hinge 620 adapted to define a second articulation axis 610 about which the third deck 500 can rotate with respect to the first deck 200. The third deck 500 may be supported by one or more wheels or rollers, such as and without limitation, third deck caster 586, or third deck drive roller 590, and may have an operationally engaged mower blade, such as third blade 562. The second connector link input end 924 may be rotatably engaged with the third deck 500 to rotate about a second operation platform linkage input-connector axis 903. The second operation platform linkage input-connector axis 903 may be substantially fixed with respect to the third deck 500. The second operation platform linkage input-connector axis 903 may be offset from the second articulation axis 610 by a second input link length 906 that is substantially fixed. The second operation platform linkage output-ground axis 902 may be offset from the second articulation axis 610 by a second ground link length 908 that is substantially fixed. In the non-limiting embodiment shown in the FIGS., second operator frame pivot axis 716, second operation platform linkage output-ground axis 902, and second operation platform linkage input-connector axis 903, are each defined by a plurality of coaxially aligned rotatable connection elements 714 fixed to the operator frame 710, the third deck 500 and the first deck 200, respectively.

In some aspects of the foregoing, it should be understood that the second connector link 920, the second output link 930, the first deck 200, and the third deck 500 may be operationally engaged so that the second operation platform linkage 900 defines a second planar quadrilateral linkage 909. In some aspects of the foregoing, it should be understood that the second operator frame pivot axis 716, the second operation platform linkage connector-output axis 901, the second operation platform linkage output-ground axis 902, and the second operation platform linkage input-connector axis 903 may be each substantially parallel to one another. In some aspects of the foregoing, it should be understood that the second operator frame pivot axis 716, the second operation platform linkage connector-output axis 901, the second operation platform linkage output-ground axis 902, and the second operation platform linkage input-connector axis 903 may be each substantially parallel to the depth direction 230. Further to the above, then, it should be understood that the second articulation axis 610 may act as a second ground-input axis 904 in the above described second planar quadrilateral linkage 909.

The above disclosed articulated mower apparatus 100 may be used in a method of mowing. In a first aspect, a method of mowing with an articulated mower apparatus 100 comprises providing an articulated mower apparatus 100. The latter articulated mower apparatus 100 comprises a first deck 200 and a second deck 300. The first deck 200 has a first deck right side and a first deck left side opposite from the first deck right side and offset in a width direction by a first deck width; a first deck front and a first deck back opposite from the first deck front and offset in a depth direction by a first deck depth; a first deck top and a first deck bottom opposite from the first deck top and offset in a height direction by a first deck height. The first deck 200 further has a first blade rotatably engaged with the first deck and adapted to be operated to contribute to a mowing operation. The first deck 200 further has a first caster adapted to support the first deck above a surface 40. It is to be understood that the latter surface may be, in some non-limiting circumstances, a surface to be mowed and that such surface may be contoured or otherwise irregular in height. The second deck 300 is operationally engaged with the first deck 200 at the left side or right side thereof by a first linkage defining a first articulation axis. The first linkage is adapted to permit the second deck to change in orientation with respect to the first deck by rotating about the first articulation axis. The second deck further has a second blade that is rotatably engaged with the second deck and is adapted to be operated to contribute to a mowing operation. The second deck further has a second caster adapted to support the second deck above the surface, and which is engaged to the second deck to be pivotable about a second caster swivel axis which is substantially fixed in orientation with respect to the second deck and adapted to rotate about the first articulation axis with respect to the first deck along with the second deck. The second deck further has a second deck drive roller rotatably engaged with the second deck about a second deck drive axis, the second deck drive axis being, substantially fixed in orientation with respect to the second deck and adapted to rotate about the first articulation axis with respect to the first deck along with the second deck. The second deck drive roller is further adapted to support the second deck above the surface and adapted to output work to the surface to promote motion of the articulated mower apparatus over the surface.

The latter first aspect of a method of mowing with an articulated mower apparatus 100 further comprises: using the second drive roller to output work to a surface to promote motion of the articulated mower apparatus over the surface; moving the articulated mower apparatus over the surface; using the first blade to contribute to the mowing operation; using the second blade to contribute to the mowing operation; and changing the orientation of the second deck with respect to the first deck.

In some optional aspects of the latter first method: the first articulation axis may be substantially parallel to the depth direction, or the first linkage may be a first hinge, or both. In some optional aspects of the latter first method, using the second blade to contribute to the mowing operation includes rotating the second blade about a second deck mow head around a second blade operational axis where the second blade operational axis is substantially fixed in orientation with respect to the second deck and adapted to rotate about the first articulation axis with respect to the first deck along with the second deck.

In some optional aspects of the latter first method: the articulated mower apparatus further comprises a third deck. In these latter optional aspects comprising a third deck, the third deck may be operationally engaged with the first deck at the left side or right side, and on the opposite side thereof from the second deck, thereof by a second linkage defining a second articulation axis, the second linkage being adapted to permit the third deck to change in orientation with respect to the first deck by rotating about the second articulation axis. In these latter optional aspects comprising a third deck, the third deck may further have a third blade rotatably engaged with the third deck and adapted to perform a mowing operation, or a third caster adapted to support the third deck above the surface, or both. The third caster may be engaged to the third deck to be pivotable about a third caster swivel axis which is fixed in orientation with respect to the third deck and adapted to rotate about the second articulation axis with respect to the first deck along with the third deck. In these latter optional aspects comprising a third deck, the third deck may further have a third deck drive roller. The third deck drive roller may be rotatably engaged with the third deck about a third deck drive axis, the third deck drive axis being, substantially fixed in orientation with respect to the third deck and adapted to rotate about the second articulation axis with respect to the first deck along with the third deck. In these latter optional aspects comprising a third deck drive roller, the third deck drive roller may be adapted to support the third deck above the surface or may be adapted to output work to the surface to promote motion of the articulated mower apparatus over the surface, or both.

In some optional aspects of the latter first method: the second articulation axis may be substantially parallel to the depth direction, or the second linkage may be a second hinge, or both. In some optional aspects of the latter first method, using the third blade to contribute to the mowing operation includes rotating the third blade about a third deck mow head around a third blade operational axis where the third blade operational axis is substantially fixed in orientation with respect to the third deck and adapted to rotate about the second articulation axis with respect to the first deck along with the third deck. Some aspects of this latter first method further comprise using the third blade to contribute to the mowing operation. Some aspects of this latter first method further comprise changing the orientation of the third deck with respect to the first deck.

Some embodiments of the present disclosure relate to a movably combined mower subframe. In a first non-limiting embodiment, a movably combined mower subframe, comprises a plurality of decks and an articulated drive system engaged to the plurality of decks. The plurality of decks has a first deck extending in a width direction, a height direction, and a depth direction; a second deck; and a third deck. The second deck is connected to the first deck by a first linkage defining a first axis of articulation about which the second deck may rotate, and the third deck is connected to the first deck by a second linkage defining a second axis of articulation about which the third deck may rotate. The articulated drive system has a second deck drive roller and a third drive roller. The second drive roller is operationally engaged with the second deck to rotate about a second deck drive axis fixedly oriented with respect to the second deck; and is adapted to rotate along with the second deck about the first axis of articulation; and adapted to apply work between a surface and the second deck to promote motion of the second deck with respect to the surface. The second deck drive axis and the first axis of articulation may be either i) perpendicular or ii) mutually orthogonal to a common perpendicular vector. The third deck drive roller is operationally engaged with the third deck to rotate about a third deck drive axis fixedly oriented with respect to the third deck; adapted to rotate with the third deck about the second axis of articulation; and is adapted to apply work between a surface and the third deck to promote motion of the third deck with respect to the surface. The third deck drive axis and the second axis of articulation may be either i) perpendicular or ii) mutually orthogonal to a common perpendicular vector. In this latter first non-limiting embodiment of a movably combined mower subframe the first linkage provides sufficient structural integrity to transmit sufficient work between the second deck to the first deck to move the first deck and the second deck over the surface during a mowing operation; and the second linkage provides sufficient structural integrity to transmit sufficient work between the third deck to the first deck to move the first deck and the third deck over the surface during a mowing operation.

Some embodiments of the present disclosure relate to a mower operation platform. In a first non-limiting embodiment, a mower operation platform comprises a first deck and an operator frame, wherein the operator frame is supported by the first deck through one or more support elements. In these latter non-limiting embodiments of a mower operation platform, the first deck is supported by one or more wheels, and has an operationally engaged mower blade. In these latter non-limiting embodiments of a mower operation platform, the operator frame has an operator frame first side and an operator frame second side opposite from the first operator frame first side and offset in a width direction by an operator frame width; an operator frame front and an operator frame back opposite from the operator frame front and offset in a depth direction by an operator frame depth; and an operator frame top and an operator frame bottom opposite the operator frame top and offset in a height direction by an operator frame height.

Some embodiments of the present disclosure relate to an active height adjustment mower suspension. In a first non-limiting embodiment, an active height adjustment mower suspension comprises a mower deck having an operationally engaged mower blade; and a slider-crank mechanism engaged with the mower deck. The slider-crank has a crank defining a height adjustment axis about which the crank is rotatably mounted to the mower deck, and a drive axis offset from the height adjustment axis by a fixed adjustment distance. The slider-crank also has a slider defined by a linear actuator, the linear actuator having a first actuator end operatively engaged to the mower deck, and a second actuator end operatively engaged to the crank to transmit work to rotate the crank about the height adjustment axis. In this latter first non-limiting embodiment of an active height adjustment mower suspension rotation of the crank about the height adjustment axis changes the position of the drive axis with respect to the mower deck.

Some embodiments of the present disclosure relate to a passive height adjustment mower suspension. In a first non-limiting embodiment, a passive height adjustment mower suspension comprises a mower deck having an operationally engaged mower blade; and a slider-crank mechanism engaged with the mower deck. The slider-crank has a crank defining a height adjustment axis about which the crank is rotatably mounted to the mower deck, and a roller axis offset from the height adjustment axis by a fixed adjustment distance. The slider-crank also has a slider defined by a slider spring, the slider spring having a first slider spring end operatively engaged to the mower deck, and a second slider spring end operatively engaged to the crank to passively output energy stored in the slider spring to rotate the crank about the height adjustment axis. In this latter first non-limiting embodiment of a passive height adjustment mower suspension, rotation of the crank about the height adjustment axis changes the position of the roller axis with respect to the mower deck.

Generally, the illustrated embodiments are not provided as strict limitations on how the disclosed aspects can be practiced by one of ordinary skill in the art but are intended to be provided as examples that can be modified, interchanged, added to or subtracted from as would be suitable to one of ordinary skill in the art to accomplish the purposes and objectives described herein.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments.

As utilized herein, relative terms and terms of degree including the term “about”, “approximately”, “substantially”, “roughly”, “near” and others are intended to incorporate ranges and variations about a qualified term reasonably encountered by one of ordinary skill in the art in fabricating, compiling or optimizing the embodiments disclosed herein to suit design preferences, where not explicitly specified otherwise. When utilized to modify a numerical description of a disclosed element, a relative term can imply a suitable range about the given number. Any implied range is intended to be consistent with and achieve the same or similar functions as described for the disclosed structure given the numerical description, where applicable. Where such ranges are not explicitly disclosed, a range within typical manufacturing tolerances associated with suitable manufacturing equipment (e.g., injection molding equipment, extrusion equipment, metal stamping equipment, and so forth) understood by one of ordinary skill in the art for realizing an element from a disclosed illustration or description can be implied. In some embodiments, depending on context and the capabilities of one of ordinary skill in the art, relative terminology can refer to a variation in a disclosed value or characteristic; e.g., a zero to two or three-percent variance, a zero to five-percent variance or a zero to ten-percent variance from precise mathematically defined value or characteristic, or any suitable value or range there between can define a scope for a disclosed term of degree. As an example, a disclosed mechanical dimension can have a variance of suitable manufacturing tolerances as would be understood by one of ordinary skill in the art, or a variance of a few percent about the disclosed mechanical dimension that would achieve a stated purpose or function of the disclosed mechanical dimension. Relative terms utilized for qualitative (rather than quantitative) description can be understood to imply explicitly stated alternatives or variations, variations understood in the art to occur from manufacturing tolerances or variations in a manufacturing process, variations understood in the art to achieve the function or purpose described for a particular component or process, or a suitable combination of the foregoing.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”, so that usage of “or” can have the same meaning as “and/or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An articulated mower apparatus, comprising:
a first deck having
a first deck right side and a first deck left side opposite from the first deck right side and offset in a width direction by a first deck width,
a first deck front and a first deck back opposite from the first deck front and offset in a depth direction by a first deck depth,
a first deck top and a first deck bottom opposite from the first deck top and offset in a height direction by a first deck height,
a first blade
rotatably engaged with the first deck,
adapted to be operated to contribute to a mowing operation, and
a first deck caster
adapted to support the first deck above a surface; and
a second deck
operationally engaged with the first deck at the left side or right side thereof by a first linkage defining a first articulation axis, the first linkage adapted to permit the second deck to rotate about the first articulation axis with respect to the first deck,
the second deck having,
a second blade
rotatably engaged with the second deck,
adapted to be operated to contribute to the mowing operation,
a second deck caster
adapted to support the second deck above the surface, and
engaged to the second deck to be pivotable about a second deck caster swivel axis which is substantially fixed in orientation with respect to the second deck and adapted to rotate about the first articulation axis with respect to the first deck along with the second deck, and
a second deck drive roller
rotatably engaged with the second deck about a second deck drive axis, the second deck drive axis being,
substantially fixed in orientation with respect to the second deck and
adapted to rotate about the first articulation axis with respect to the first deck along with the second deck,
adapted to support the second deck above the surface, and
adapted to output work to the surface to promote motion of the articulated mower apparatus over the surface.

2. The articulated mower apparatus of claim 1, wherein the second blade is operable by being rotated about a second deck mow head around a second blade operational axis, the second blade operational axis being substantially fixed in orientation with respect to the second deck and adapted to rotate about the first articulation axis with respect to the first deck along with the second deck.

3. The articulated mower apparatus of claim 2, further comprising a third deck operationally engaged with the first deck at the right side or left side thereof, and on a side of the first deck opposite from the second deck, by a second linkage defining a second articulation axis, the second linkage adapted to permit the third deck to change in orientation with respect to the first deck by rotating about the second articulation axis,
the third deck having,
a third blade
rotatably engaged with the third deck, and
adapted to be operated to contribute to a mowing operation;
a third deck caster
being adapted to support the third deck above the surface, and
the third deck caster engaged to the third deck to be pivotable about a third deck caster swivel axis which is fixed in orientation with respect to the third deck, and
the third deck caster adapted to rotate about the second articulation axis with respect to the first deck along with the third deck; and
a third deck drive roller
rotatably engaged with the third deck about a third deck drive axis, the third deck drive axis being,
substantially fixed in orientation with respect to the third deck, and
adapted to rotate about the second articulation axis with respect to the first deck along with the third deck,
adapted to support the third deck above the surface, and
adapted to output work to the surface to promote motion of the articulated mower apparatus over the surface.

4. The articulated mower apparatus of claim 3, wherein the third blade is operable by being rotated about a third deck mow head around a third blade operational axis, the third blade operational axis being substantially fixed in orientation with respect to the third deck and adapted to adapted to rotate about the second articulation axis with respect to the first deck along with the third deck.

5. The articulated mower apparatus of claim 4, wherein
the first articulation axis is within 5 degrees of parallel to the depth direction; and
the second articulation axis is within 5 degrees of parallel to the depth direction.

6. The articulated mower apparatus of claim 5, wherein the first articulation axis, the second deck drive axis, and the second deck caster swivel axis are mutually orthogonal to one another.

7. The articulated mower apparatus of claim 6, wherein the second articulation axis, the third deck drive axis, and the third deck caster swivel axis are mutually orthogonal to one another.

8. A method of mowing with an articulated mower apparatus, comprising:
providing an articulated mower apparatus, having
a first deck having
a first deck right side and a first deck left side opposite from the first deck right side and offset in a width direction by a first deck width,
a first deck front and a first deck back opposite from the first deck front and offset in a depth direction by a first deck depth,
a first deck top and a first deck bottom opposite from the first deck top and offset in a height direction by a first deck height,
a first blade
rotatably engaged with the first deck,
adapted to be operated to contribute to a mowing operation, and
a first deck caster
adapted to support the first deck above a surface, and
a second deck
operationally engaged with the first deck at the left side or right side thereof by a first linkage defining a first articulation axis, the first linkage adapted to permit the second deck to change in orientation with respect to the first deck by rotating about the first articulation axis,
the second deck having,
a second blade
rotatably engaged with the second deck,
adapted to be operated to contribute to a mowing operation, and
a second deck caster
adapted to support the second deck above the surface, and
engaged to the second deck to be pivotable about a second deck caster swivel axis which is substantially fixed in orientation with respect to the second deck and adapted to rotate about the first articulation axis with respect to the first deck along with the second deck, and
a second deck drive roller
rotatably engaged with the second deck about a second deck drive axis, the second deck drive axis being,
substantially fixed in orientation with respect to the second deck and
adapted to rotate about the first articulation axis with respect to the first deck along with the second deck,
adapted to support the second deck above the surface, and
adapted to output work to the surface to promote motion of the articulated mower apparatus over the surface;
using the second deck drive roller to output work to a surface to promote motion of the articulated mower apparatus over the surface;
moving the articulated mower apparatus over the surface;
using either the first blade or the second blade to contribute to a mowing operation; and
changing the orientation of the second deck with respect to the first deck.

9. The method of mowing with an articulated mower apparatus of claim 8, wherein using the second blade to contribute to the mowing operation includes rotating the second blade about a second deck mow head around a second blade operational axis, the second blade operational axis being substantially fixed in orientation with respect to the second deck and adapted to rotate about the first articulation axis with respect to the first deck along with the second deck.

10. The method of mowing with an articulated mower apparatus of claim 9, wherein the articulated mower apparatus further comprises a third deck,
operationally engaged with the first deck at the left side or right side, and on a side of the first deck opposite from the second deck, thereof by a second linkage defining a second articulation axis, the second linkage adapted to permit the third deck to change in orientation with respect to the first deck by rotating about the second articulation axis,
the third deck having,
a third blade
rotatably engaged with the third deck, and
adapted to perform a mowing operation;
a third deck caster
being adapted to support the third deck above the surface, and
the third deck caster engaged to the third deck to be pivotable about a third deck caster swivel axis which is fixed in orientation with respect to the third deck, and
the third deck caster adapted to rotate about the second articulation axis with respect to the first deck along with the third deck; and
a third deck drive roller
rotatably engaged with the third deck about a third deck drive axis, the third deck drive axis being,
substantially fixed in orientation with respect to the third deck and adapted to rotate about the second articulation axis with respect to the first deck along with the third deck,
adapted to support the third deck above the surface, and
adapted to output work to the surface to promote motion of the articulated mower apparatus over the surface.

11. The method of mowing with an articulated mower apparatus of claim 10, wherein the third blade is operable by being rotated about a third deck mow head around a third blade operational axis, the third blade operational axis being substantially fixed in orientation with respect to the third deck and adapted to adapted to rotate about the second articulation axis with respect to the first deck along with the third deck.

12. The method of mowing with an articulated mower apparatus of claim 11, further comprising using the third blade to contribute to the mowing operation.

13. The method of mowing with an articulated mower apparatus of claim 12, further comprising changing the orientation of the third deck with respect to the first deck.

14. The method of mowing with an articulated mower apparatus of claim 13, wherein
the first articulation axis is within 5 degrees of parallel to the depth direction; and
the second articulation axis is within 5 degrees of parallel to the depth direction.

15. The method of mowing with an articulated mower apparatus of claim 14, wherein the first articulation axis, the second deck drive axis, and the second deck caster swivel axis are mutually orthogonal to one another.

16. The method of mowing with an articulated mower apparatus of claim 15, wherein the second articulation axis, the third deck drive axis, and the third deck caster swivel axis are mutually orthogonal to one another.

17. An articulated mower apparatus, comprising:
a first deck having
a first deck right side and a first deck left side opposite from the first deck right side and offset in a width direction by a first deck width,
a first deck front and a first deck back opposite from the first deck front and offset in a depth direction by a first deck depth,
a first deck top and a first deck bottom opposite from the first deck top and offset in a height direction by a first deck height,
a first blade
rotatably engaged with the first deck,
adapted to contribute to a mowing operation,
wherein the first blade is operable to contribute to the mowing operation by being rotated about a first deck mow head around a first blade
operational axis, the first blade operational axis being fixed in orientation with respect to the first deck,
a first deck caster adapted to support the first deck above a surface, and
a first rear support roller adapted to support the first deck above the surface;
a second deck
operationally engaged with the first deck at the left side thereof by a first hinge defining a first articulation axis, the first hinge adapted to permit the second deck to rotate about the first articulation axis with respect to the first deck,
the second deck having,
a second blade
rotatably engaged with the second deck,
adapted to contribute to the mowing operation,
wherein the second blade is operable to contribute to the mowing operation by being rotated about a second deck mow head around a second blade operational axis, the second blade operational axis being fixed in orientation with respect to the second deck and
adapted to rotate about the first articulation axis with respect to the first deck along with the second deck,
a second deck caster
adapted to support the second deck above the surface, and
engaged to the second deck to be pivotable about a second deck caster swivel axis which is substantially fixed in orientation with respect to the second deck and adapted to rotate about the first articulation axis with respect to the first deck along with the second deck, and
a second deck drive roller
rotatably engaged with the second deck about a second deck drive axis, the second deck drive axis being
substantially fixed in orientation with respect to the second deck and
adapted to rotate about the first articulation axis with respect to the first deck along with the second deck,
adapted to support the second deck above the surface, and
adapted to output work to the surface to promote motion of the articulated mower apparatus; and
a third deck
operationally engaged with the first deck at the right side thereof by a second hinge defining a second articulation axis, the second hinge adapted to permit the third deck to rotate about the second articulation axis with respect to the first deck,
the third deck having,
a third blade
rotatably engaged with the third deck,
adapted to contribute to the mowing operation,
wherein the third blade is operable to contribute to the mowing operation by being rotated about a third deck mow head around a third blade operational axis, the third blade operational axis being fixed in orientation with respect to the third deck and adapted to rotate about the second articulation axis with respect to the first deck along with the third deck, and
a third deck caster
adapted to support the third deck above the surface, and
engaged to the third deck to be pivotable about a third deck caster swivel axis which is substantially fixed in orientation with respect to the third deck and adapted to rotate about the second articulation axis with respect to the first deck along with the third deck, and
a third deck drive roller
rotatably engaged with the third deck about a third deck drive axis, the third deck drive axis being
substantially fixed in orientation with respect to the third deck, and
adapted to rotate about the second articulation axis with respect to the first deck along with the third deck,
adapted to support the third deck above the surface, and
adapted to output work to the surface to promote motion of the articulated mower apparatus.

18. The articulated mower apparatus of claim 17, wherein the first articulation axis is parallel to the second articulation axis.

19. The articulated mower apparatus of claim 18, wherein
the first articulation axis, the second deck drive axis, and the second deck caster swivel axis are mutually orthogonal to one another; and
the second articulation axis, the third deck drive axis and the third deck caster swivel axis are mutually orthogonal to one another.

20. The articulated mower apparatus of claim 19, wherein
the second blade operational axis is parallel to the second deck caster swivel axis; and
the third blade operational axis is parallel to the third deck caster swivel axis.
